(19) United States
(12) Patent Application Publication
(10) Pub. No.: US 2024/0317911 A1
(43) Pub. Date: Sep. 26, 2024

(54) CURE OF ANHYDRIDE FUNCTIONALIZED POLYMERS WITH MULTIFUNCTIONAL EPOXY COMPOUNDS OR OXETANE COMPOUNDS

(71) Applicant: Dow Global Technologies LLC, Midland, MI (US)

(72) Inventors: Chao He, Shanghai (CN); Hongyu Chen, Shanghai (CN); Wanfu Ma, Shanghai (CN); Xin Tan, Shanghai (CN); Wuye Ouyang, Shanghai (CN); Allan Walter Mclennaghan, Lachen (CH); Juan C. Tuberquia, Manvel, TX (US)

(21) Appl. No.: 18/578,562

(22) PCT Filed: Sep. 19, 2021
(86) PCT No.: PCT/CN2021/119474

§ 371 Date: Jan. 11, 2024

(51) Int. Cl. C08F 210/06; C08F 255/02

(52) U.S. Cl. CPC C08F 210/06; C08F 255/02; C08F 2810/20

(57) ABSTRACT

A process to form a composition, said process comprising at least the following steps A) and B): A) mixing together at least the following components a and b to form a first composition: a) the “anhydride-functionalized olefin-based polymer”, and b) at least one multifunctional epoxy compound comprising at least two epoxy groups, or at least one oxetane compound comprising at least one oxetane group; B) exposing the first composition to moisture to form the crosslinked olefin-based polymer. Also, related is first compositions and crosslinked compositions.

### BACKGROUND OF THE INVENTION

Thermoplastics usually have to be cured before they can be successfully used in applications needing high temperature resistance, since such polymers will melt, when the temperature is higher than their melting temperature. Many curing chemistries for polymers were developed in previous decades, such as sulfur curing, peroxide curing and moisture curing. However, these curing chemistries may suffer from premature crosslinking during the preparation of the polymer formulation and/or during the processing of the polymer formulation. For example, in an extrusion process, the extrusion temperature cannot be too high, and the residence time cannot be too long, in order to avoid the early stage curing (scorch), in the extrusion of a thermoplastic, crosslinked using sulfur, peroxide, or moisture. The polymer formulations containing these curing agents are typically not stable at high temperatures, for the time needed to complete the process at hand. Therefore, there is a need for curing processes, and related formulations, which have wide processing windows (long time operation window at high temperature).

Also, in hot melt adhesives (HMA), there is a need for polymer formulations of high heat resistance to withstand high service temperatures. The incumbent curing chemistry is POLYURETHANE REACTIVE (PUR) that uses NCO chemistry. However, the toxicity of the NCO increases its exposure risk to workers, and the high reactivity of the NCO results in premature curing. Thus, there is a need to replace the “PUR” chemistry with more environmentally friendly polymer formulations that provide better controlled of the curing process.

U.S. Pat. No. 7,732,529 discloses an acrylic block copolymer composition for improving melt flowability and other features, and which is formed by a thermoplastic elastomer composition comprising the following: i) an acrylic block copolymer (A), which comprises a methacrylic polymer block (a) and an acrylic polymer block (b), wherein at least one of the polymer blocks among the methacrylic polymer block (a) and the acrylic polymer block (b) has an acid anhydride group and/or a carboxyl group; and ii) an acrylic polymer (B) having 1.1 or more of epoxy groups in one molecule. See abstract. The acrylic polymer B includes ARUFON XG4000, ARUFON XG4010, ARUFON XD945, ARUFON XD950, ARUFON UG4030, and ARUFON UG4070 of Toagosei Co., Ltd. These are acrylic polymers, such as all acryl and acrylate/styrene, and 1.1 or more of the epoxy groups are contained in a molecule. See column 18, lines 53-60.

U.S. Pat. No. 7,267,878 discloses a one part hot-melt adhesive composition in the form of particles and comprised of the following: (a) one or more polymeric constituents, wherein at least one of the polymeric constituents contains one or more isocyanate groups and a polyester component, and (b) at least one tackifying resin; and wherein said particles remain pourable at temperatures up to 45° C., and comprise at least one material selected from the group consisting of radiation-curable polymers and monomers. See claim 3. The at least one material may contain groups selected from the group consisting of olefinically unsaturated groups, epoxide groups and combinations thereof. See claim 4.

U.S. Pat. No. 5,210,150 discloses moisture-curable, melt-processible adhesives obtained by reacting certain ethylene copolymers containing an n-alkyl acrylate and a carefully limited amount of a carboxylic acid, with a stoichiometric amount of an epoxy-silane (see abstract). Additional curable polymer formulations are disclosed in the following references: U.S. Pat. Nos. 8,399,571, 8,569,417 and U.S. Publication 2020/0216730. However, as discussed above, there remains a need for curing processes, and related formulations, which have wide processing windows (long time operation window at high temperature), and a need for more eco-friendly polymer formulations that provide for a better controlled of the curing process. These needs have been met by the following invention.

### SUMMARY OF THE INVENTION

In a first aspect, a process to form a composition comprising a crosslinked olefin-based polymer derived from an “anhydride-functionalized olefin-based polymer,” said process comprising at least the following steps A) and B):
A) mixing together at least the following components a and b to form a first composition:
   a) the “anhydride-functionalized olefin-based polymer, and
   b) at least one multifunctional epoxy compound comprising at least two epoxy groups, or at least one oxetane compound comprising at least one oxetane group;
B) exposing the first composition to moisture to form the crosslinked olefin-based polymer.

In a second aspect, a first composition comprising at least the following components a and b:
a) an “anhydride-functionalized olefin-based polymer;”
b) at least one multifunctional epoxy compound comprising at least two epoxy groups, or at least one oxetane compound comprising at least one oxetane group.

### BRIEF DESCRIPTION OF THE DRAWINGS

FIG. 1 depicts an overlay of FTIR profiles as follows, from top to bottom: a) AFFINITY GA 1000R-Acid, b) AFFINITRY GA 1000R-Anhydride, c) Composition IE 1 after preparation (180° C., 1 hr), d) Composition IE 1 after curing at 22° C./50% RH for 3 days, and e) Composition IE 1 after curing at 22° C./50% RH for 8 days.

### DETAILED DESCRIPTION OF THE INVENTION

New compositions, and crosslinking processes using the same, have been discovered, which provide low viscosity formulations with good thermal stability, and provide excellent high temperature operation windows (for example, viscosity <16,000 mPa's at 177° C., and a viscosity increase <60% after 3 hours at 177° C.), and high Shear Adhesion Failure Temperature (SAFT)>125° C. or >130° C. after curing for 7 days at 85° C./85% RH, in air. In particular, high temperature resistant, hot melt adhesives (HMAs) have been discovered, along with the cure processes for the same.

It has been unexpectedly discovered that when a multifunctional epoxy compound or an oxetane compound is mixed with an anhydride functionalized olefin-based polymer, at high temperature, the anhydride form is highly favored over the diacid form, and the anhydride does not react with epoxy or oxetane to any significant extent. As such, the viscosity of the polymer composition is stable for a long time at high temperature. After the composition (physical blend) is prepared, it can be moisture cured in a controlled manner. It was unexpectedly discovered that, in the presence of moisture, the anhydride will convert to a di-acid form, and one acid group will react with epoxy or oxetane to form the chemical bond between polymer and the crosslinking agent (see for example, Scheme 1 below). Moreover, some curing catalysts, such as diisopropyl-2-hydroxybenzoic acid chromium(III) or acetylacetone chromium(III) salt, may be added to improve cure.

As discussed above, in a first aspect, a process to form a composition comprising a crosslinked olefin-based polymer derived from an “anhydride-functionalized olefin-based polymer,” is provided, and said process comprising at least the following steps A) and B), as discussed above. In a second aspect, first composition comprising at least the following components a and b, as discussed above.

An inventive process may comprise a combination of two or more embodiments, as described herein. An inventive composition may comprise a combination of two or more embodiments, as described herein. Each component a) and b) may, independently, comprise a combination of two or more embodiments, as described herein.

The following embodiments apply to the first and second aspects of the invention, unless otherwise noted.

In one embodiment, or a combination of two or more embodiments, each described herein, the multifunctional epoxy compound is selected from structures e11), e12), e21), e31), e41), e51), e71) or 81) as described herein; and the oxetane compound is selected from 041) as described herein. See G] below.

In one embodiment, or a combination of two or more embodiments, each described herein, component b is at least one multifunctional epoxy compound.

In one embodiment, or a combination of two or more embodiments, each described herein, component b is at least one oxetane compound.

In one embodiment, or a combination of two or more embodiments, each described herein, component a is an anhydride-functionalized ethylene-based polymer, and further an anhydride-functionalized ethylene/alpha-olefin interpolymer, and further an anhydride-functionalized ethylene/alpha-olefin copolymer.

In one embodiment, or a combination of two or more embodiments, each described herein, component a is an anhydride-functionalized propylene-based polymer, and further an anhydride-functionalized propylene/ethylene interpolymer or an anhydride-functionalized propylene/alpha-olefin interpolymer, and further an anhydride-functionalized propylene/ethylene copolymer or an anhydride-functionalized propylene/alpha-olefin copolymer.

In one embodiment, or a combination of two or more embodiments, each described herein, component a has a density ≥0.860 g/cc, or ≥0.862 g/cc, or ≥0.864 g/cc, or ≥0.866 g/cc, or ≥0.868 g/cc, or ≥0.870 g/cc, or ≥0.872 g/cc, and/or ≤0.920 g/cc, or ≤0.915 g/cc, or ≤0.910 g/cc, or ≤0.905 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.878 g/cc (1 cc=1 cm³).

In one embodiment, or a combination of two or more embodiments, each described herein, the weight ratio of component a to component b is ≥20, or ≥22, or ≥24, or ≥26, or ≥28, or ≥30, or ≥32, and/or ≤90, or ≤88, or ≤86, or ≤84, or ≤82, or ≤80, or ≤78, or ≤76, or ≤74, or ≤72, or ≤70.

In one embodiment, or a combination of two or more embodiments, each described herein, the first composition further comprises a tackifier (component c).

In one embodiment, or a combination of two or more embodiments, each described herein, the first composition has a percent increase in melt viscosity at 177° C. (% Δη3 at 177° C.)≤65%, or ≤60%, or ≤55%, and/or ≥8.0%, or ≥10%, or ≥12%, or ≥14%, or ≥16%; and where % Δη3 at 177° C.=[(η3−η1)/η1]×100, and where η3 is the melt viscosity after 3 hours at 177° C., and η1 is the melt viscosity after 1 hour at 177° C.

In one embodiment, or a combination of two or more embodiments, each described herein, the first composition, after seven days at 85° C., 85% RH, in air, has SAFT value ≥ 100° C., or ≥115° C., or ≥120° C., or ≥125° C., or ≥130° C. and/or ≤200° C., or ≤190° C., or ≤185° C., or ≤180° C., or ≤175° C., or ≤170° C.

Also provided is crosslinked composition formed from a process or from a first composition of any one embodiment, or a combination of two or more embodiments, each described herein.

Also provided is an article comprising at least one component formed from the composition of any one embodiment, or a combination of two or more embodiments, each described herein.

### Anhydride-Functionalized Olefin-Based Polymers

An “anhydride-functionalized olefin-based polymer” is a olefin-based polymer with anhydride moieties bonded to the olefin-based polymer chain (for example, an anhydride moiety grafted to an ethylene/α-olefin interpolymer, or to a propylene/ethylene interpolymer). Nonlimiting examples of suitable anhydrides include maleic anhydride (MAH), and itaconic anhydride, citraconic anhydride, tetrahydrophthalic anhydride, bromomaleic anhydride, chloromaleic anhydride, nadic anhydride, methylnadic anhydride, and alkenylsuccinic anhydride.

Nonlimiting examples of suitable ethylene-based polymers include ethylene homopolymers, ethylene/alpha-olefin interpolymers, and ethylene/alpha-olefin copolymers. Nonlimiting examples of suitable alpha-olefins include C3-C20 alpha-olefins, or C3-C10 alpha-olefins, or C3-C8 alpha-olefins.

Nonlimiting examples of suitable propylene-based polymers include propylene homopolymers, propylene/ethylene interpolymers and copolymers, and propylene/alpha-olefin interpolymers and copolymers. Nonlimiting examples of suitable alpha-olefins include C4-C20 alpha-olefins, or C4-C10 alpha-olefins, or C4-C8 alpha-olefins.

Additional anhydride-functionalized olefin-based polymer include, but are not limited to, anhydride-functionalized ethylene/alpha-olefin interpolymers and copolymers, anhydride-functionalized propylene/alpha-olefin interpolymers and copolymers, anhydride-functionalized propylene/ethylene interpolymers and copolymers, anhydride-functionalized olefin block copolymers (anhydride-fn-OBCs), EVA functionalized with an anhydride (for example, grafted MAH), APAO (amorphous polyalpha-olefin) functionalized an anhydride (for example, grafted MAH), EMA (ethylene methyl acrylate) functionalized with an anhydride (for example, grafted MAH), EBA (ethylene butyl acrylate) functionalized with an anhydride (for example, grafted MAH).

### Tackifiers

Tackifiers are known in the art, and may be solids, semi-solids, or liquids at room temperature. Preferred tackifiers include aliphatic, cycloaliphatic and aromatic hydrocarbons, modified hydrocarbons, and hydrogenated versions of such hydrocarbons.

### Waxes

Waxes include, but are not limited to, paraffin waxes; microcrystalline waxes; high density, low molecular weight polyethylene waxes or polypropylene waxes; thermally degraded waxes; by-product polyethylene waxes; and Fischer-Tropsch waxes. In one embodiment, the first composition comprises a wax, and further from 1 to 40 wt % of the wax, based on the weight of the first composition.

### Additives and Applications

A first composition may comprise one or more additives. Additives include, but are not limited to, cure catalysts, fillers, pigments, UV stabilizers, antioxidants, processing aids, plasticizers, solvents, and further cure catalysts, UV stabilizers, and anti-oxidants. In one embodiment, an additive is present in an amount ≥0.01 wt %, or ≥0.02 wt %, or ≥0.05 wt %, or ≥0.10 wt %, or ≥0.20 wt % and/or ≤40 wt %, or ≤20 wt %, or ≤10 wt %, or ≤5.0 wt %, or ≤2.0 wt %, or ≤1.5 wt %, or ≤1.0 wt %, or ≤0.90 wt %, or ≤0.80 wt %, or ≤0.70 wt %, or ≤0.60 wt %, or ≤0.50 wt %, or ≤0.40 wt %, or ≤0.30 wt %, based on the weight of the first composition. Some acid and epoxy reaction catalysts, such as diisopropyl-2-hydroxybenzoic acid chromium(III) (CAS: 743373-40-2) and acetylacetone chromium(III) salt (CAS: 21679-31-2) may also be added to further improve the curing performance (for example, from 0.1 to 1.0 wt % of the catalyst, based on the weight of the first composition).

The first composition may comprise one or more polymer(s) different from the anhydride-functionalized olefin-based polymer (component a). For example, polymers such as polar copolymers such as acrylates and vinyl acetates with ethylene, or polymer blends of a polar copolymer and a non-polar olefin-based polymer. In one embodiment, an additional polymer or polymer blend is present in an amount ≥0.5 wt %, or ≥1.0 wt %, or ≥2.0 wt %, or ≥3.0 wt %, or ≥4.0 wt % and/or ≤10 wt %, or ≤9.0 wt %, or ≤8.0 wt %, or ≤7.0 wt %, or ≤6.0 wt %, or ≤5.0 wt %, based on the weight of the first composition.

The components of the first composition may be mixed at high temperature in an extruder or in mixing vessels, as is typical for the hot melt adhesive industry. The order of addition of the components can be further optimized to ensure the most stable formulation results. For example, all of the components can be added in one mixing vessel, or if more appropriate, the anhydride-functionalized polymer and the epoxy-silane can be mixed separately first, and in a separate step, then mixed with the rest of the components.

The excellent stability and crosslinking features make the inventive compositions well suited for adhesive applications. The compositions are suitable for those applications in which a long open time is required, such as woodworking or bookbinding applications. Many other applications will benefit from the delayed curing of the compositions. Moisture curing might occur at high or low temperature, even at room temperature, but then over a longer time.

### Definitions

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers (for example, antioxidants).

The term “interpolymer,” as used herein, refers to a polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers. Olefin-based polymers include, but are not limited to, ethylene/alpha-olefin interpolymers and copolymers, propylene/alpha-olefin interpolymers and copolymers, propylene/ethylene interpolymers and copolymers, olefin block copolymer (OBC), EVA, APAO (amorphous polyalpha-olefin), EMA (ethylene/methyl acrylate), and EBA (ethylene/butyl acrylate).

The term “ethylene-based polymer,” as used herein, refers to a polymer that comprises, in polymerized form, 50 wt % or a majority weight percent of ethylene (based on the weight of the polymer), and optionally may comprise one or more comonomers. In one embodiment, the ethylene-based polymer comprises, in polymerized form, ≥55 wt %, or ≥60 wt %, or ≥65 wt %, or ≥70 wt %, or ≥75 wt %, or ≥80 wt %, or ≥85 wt %, or ≥90 wt % ethylene, based on the weight of the polymer.

The term “ethylene/alpha-olefin interpolymer,” as used herein, refers to a random interpolymer that comprises, in polymerized form, 50 wt % or a majority weight percent of ethylene (based on the weight of the interpolymer), and an alpha-olefin. In one embodiment, the ethylene/alpha-olefin interpolymer comprises, in polymerized form, ≥55 wt %, or ≥60 wt %, or ≥65 wt %, or ≥70 wt %, or ≥75 wt %, or ≥80 wt %, or ≥85 wt %, or ≥90 wt % ethylene, based on the weight of the interpolymer.

The term “ethylene/alpha-olefin copolymer,” as used herein, refers to a random copolymer that comprises, in polymerized form, 50 wt % or a majority weight percent of ethylene (based on the weight of the copolymer), and an alpha-olefin, as the only two monomer types. In one embodiment, the ethylene/alpha-olefin copolymer comprises, in polymerized form, ≥55 wt %, or ≥60 wt %, or ≥65 wt %, or ≥70 wt %, or ≥75 wt %, or ≥80 wt %, or ≥85 wt %, or ≥90 wt % ethylene, based on the weight of the copolymer.

The term “propylene-based polymer,” as used herein, refers to a polymer that comprises, in polymerized form, a majority weight percent of propylene (based on the weight of the polymer), and optionally may comprise one or more comonomers. In one embodiment, the propylene-based polymer comprises, in polymerized form, ≥55 wt %, or ≥ 60 wt %, or ≥65 wt %, or ≥70 wt %, or ≥75 wt %, or ≥80 wt %, or ≥85 wt %, or ≥90 wt % propylene, based on the weight of the polymer.

The term “propylene/alpha-olefin interpolymer,” as used herein, refers to a random interpolymer that comprises, in polymerized form, a majority weight percent of propylene (based on the weight of the interpolymer), and an alpha-olefin. In one embodiment, the propylene/alpha-olefin interpolymer comprises, in polymerized form, ≥55 wt %, or ≥60 wt %, or ≥65 wt %, or ≥70 wt %, or ≥75 wt %, or ≥80 wt %, or ≥85 wt %, or ≥90 wt % propylene, based on the weight of the interpolymer.

The term “propylene/alpha-olefin copolymer,” as used herein, refers to a random copolymer that comprises, in polymerized form, a majority weight percent of propylene (based on the weight of the copolymer), and an alpha-olefin, as the only two monomer types. In one embodiment, the propylene/alpha-olefin copolymer comprises, in polymerized form, ≥ 55 wt %, or ≥60 wt %, or ≥65 wt %, or ≥70 wt %, or ≥75 wt %, or ≥80 wt %, or ≥85 wt %, or ≥90 wt % propylene, based on the weight of the copolymer.

The term “propylene/ethylene interpolymer,” as used herein, refers to a random interpolymer that comprises, in polymerized form, a majority weight percent of propylene (based on the weight of the interpolymer), and ethylene. In one embodiment, the propylene/ethylene interpolymer comprises, in polymerized form, ≥55 wt %, or ≥60 wt %, or ≥65 wt %, or ≥70 wt %, or ≥75 wt %, or ≥80 wt %, or ≥85 wt %, or ≥90 wt % propylene, based on the weight of the interpolymer.

The term “propylene/ethylene copolymer,” as used herein, refers to a random copolymer that comprises, in polymerized form, a majority weight percent of propylene (based on the weight of the copolymer), and ethylene, as the only two monomer types. In one embodiment, the propylene/ethylene copolymer comprises, in polymerized form, ≥55 wt %, or ≥60 wt %, or ≥65 wt %, or ≥70 wt %, or ≥75 wt %, or ≥80 wt %, or ≥85 wt %, or ≥90 wt % propylene, based on the weight of the copolymer.

The term “anhydride-functionalized olefin-based polymer,” as used herein, refers to an olefin-based polymer that comprises anhydride groups. Such anhydride groups may be derived from maleic anhydride or other anhydride compounds. The anhydride groups may be converted to carboxylic acid groups by reaction with water. In one embodiment, the anhydride groups are grafted onto the olefin-based polymer.

The phrase “a majority weight percent,” as used herein, in reference to a polymer (or interpolymer or copolymer), refers to the amount of monomer present in the greatest amount in the polymer.

The term “crosslinked olefin-based polymer,” as used herein, is understood by those skilled in the art, and refers to a polymer that has a network structure due to the formation of chemical bonds between polymer chains.

The phrase “crosslinked olefin-based polymer derived from an “anhydride-functionalized olefin-based polymer,” as used herein, refers to the crosslinking (or curing) of the “anhydride-functionalized olefin-based polymer” with at least one multifunctional epoxy compound or at least one oxetane compound, to form the “crosslinked olefin-based polymer.”

The term “multifunctional epoxy compound,” as used herein, refers to a compound comprising at least two epoxy groups (for example,

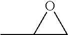

). See, for examples, structures e11), e12), e21), e31), e41), e51), e71) and e81) below.

The term “oxetane compound,” as used herein, refers to a compound comprising at least one oxetane groups (for example,

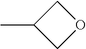

), and further at least two oxetane groups. See, for examples, structure o41) below.

The term “Percent Relative Humidity (% RH)” is the amount of water vapor present in air, and expressed as a percentage of the amount needed for saturation at the same temperature. The % RH can be measured using a humidity meter, such as a hygrometer or humidity gage—each measuring the relative humidity in air.

The phrase “exposing the first composition to moisture,” as used herein, refers to contacting the first composition to an atmosphere that contains water, typically in the gaseous state. Such an exposure can occur, for example, in air or in an air oven set at a particular % RH.

The terms “hydrocarbon,” “hydrocarbyl group,” and similar terms, as used herein, refer to, respectively, a chemical compound or chemical group, etc., containing only carbon and hydrogen atoms. The hydrocarbon or hydrocarbyl group may be linear or branched.

The term “alkyl group,” as used herein, refers to a monovalent chemical group containing only carbon and hydrogen atoms and only single bonds. The alkyl group may be linear or branched.

The terms “hydrocarbylene,” “hydrocarbylene group,” and similar terms used herein, refer to, respectively, a divalent hydrocarbon, or a divalent hydrocarbon group, etc. . . . The hydrocarbylene or hydrocarbylene group may be linear or branched.

The term “alkylene group,” as used herein, refers to a divalent chemical group containing only carbon and hydrogen atoms and only single bonds. The alkylene group may be linear or branched.

The phrases “thermally treated,” “thermally treating,” “thermal treatment,” and similar phrases, as used herein, in reference to a first composition, refer to increasing the temperature of the composition by the application of, for example, heat or radiation. Note, the temperature at which the thermal treatment takes place, refers to the temperature of the composition (for example, the melt temperature of the composition. Typically, the temperature of the composition is equilibrated in a relatively short period to the temperature of the heating device (for example, an oven).

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include, for example, any additional additive, adjuvant, or compound, whether polymeric or otherwise, unless stated to the contrary. In contrast, the term “consisting essentially of” excludes from the scope of any succeeding recitation any other component, step or procedure, excepting those that are not essential to operability. The term “consisting of” excludes any component, step or procedure, not specifically delineated or listed.

### Listing of Some Process and Composition Features

A] A process to form a composition comprising a crosslinked olefin-based polymer derived from an “anhydride-functionalized olefin-based polymer,” said process comprising at least the following steps A) and B):
A) mixing together at least the following components a and b to form a first composition:
   a) the “anhydride-functionalized olefin-based polymer, and
   b) at least one multifunctional epoxy compound comprising at least two epoxy groups, or at least one oxetane compound comprising at least one oxetane group, and further at least two oxetane groups;
B) exposing the first composition to moisture to form the crosslinked olefin-based polymer.
B] The process of A] above, wherein step A takes place at a temperature ≥120° C., or ≥ 130° C., or ≥140° C., or ≥150° C., or ≥160° C., or ≥165° C., or ≥170° C., or ≥175° C., or ≥180° C., and/or ≤220° C., or ≤215° C., or ≤210° C., or ≤205° C., or ≤200° C., or ≤195° C., or ≤190° C.
C] The process of A] or B] above, wherein step A takes place at a percent relative humidity (% RH)≥10%, or ≥15%, or ≥20%, or ≥25%, or ≥30%, or ≥35%, or ≥40%, and/or ≤60%, or ≤55%, or ≤50%, or ≤45%.
D] The process of any one of A]-C] (A] through C]) above, wherein the molar ratio of the epoxy groups on the multifunctional epoxy compound or the oxetane groups on the oxetane compound to the anhydride groups on the “anhydride-functionalized olefin-based polymer” is ≥0.20, or ≥0.40, or ≥0.60, or ≥0.80, or ≥0.85, or ≥0.90, or ≥0.95, or ≥1.00, and/or ≤5.00, or ≤4.50, or ≤4.00, or ≤3.50, or ≤3.00, or ≤2.50, or ≤2.00, or ≤1.90, or ≤1.80, or ≤1.70, or ≤1.60, or ≤1.50, or ≤1.40, or ≤1.35.
E] The process of any one of A]-D] above, wherein the at least one multifunctional epoxy compound of component b is selected from one of structures e1) to e8) below:

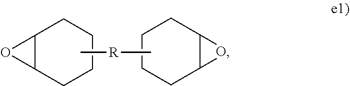

wherein R is selected from the following:
i) a hydrocarbylene group, and further an alkylene group;
ii) a hydrocarbylene-O-hydrocarbylene group, and further an alkylene-O-alkylene group;
iii) a (CH₂)n-OC(O)-hydrocarbylene-OC(O)—(CH₂)n group, where each n is independently ≥0, and further a (CH₂)n-OC(O)-alkylene-OC(O)—(CH₂)n group, where each n is independently ≥0; and further each n is the same;
iv) a (CH₂)n-O-hydrocarbylene-O—(CH₂)n group, where each n is independently ≥0, and further a (CH₂)n-O-alkylene-O—(CH₂)n group, where each n is independently ≥0, and further each n is the same; or
v) a hydrocarbylene-Si(X¹)(X²)—O—Si(X³)(X⁴)-hydrocarbylene, where X¹, X², X³ and X⁴ are each independently an alkyl group, and further X1=X2=X3=X⁴; and further an alkylene-Si(X¹)(X²)—O—Si(X³)(X⁴)-alkylene, where X¹, X², X³ and X⁴ are each independently an alkyl group, and further X1=X2=X3=X⁴;

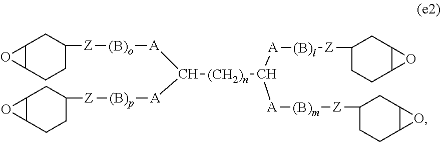

wherein each A (from C to A to B) is independently a hydrocarbylene group, a hydrocarbylene-C(O) group, or a C(O) group, and further an alkylene group, an alkylene-C(O) group, or a C(O) group, and further an alkylene-C(O) group, or a C(O) group;
each B (from A to B to Z) is independently an O-hydrocarbylene-C(O) group, or an O-hydrocarbylene group, further an O-alkylene-C(O) group, or an O-alkylene group, and further each B is the same; each Z (from B to Z to ring) is independently an O-hydro-carbylene group or a hydrocarbylene group, further an O-alkylene group or an alkylene group, and further each Z is the same; and n≥0; 1≥0, m≥0, o≥0, p≥0;

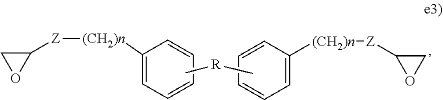

wherein R is selected from the following:
i) a hydrocarbylene group, further an alkylene group;
ii) a hydrocarbylene-O-hydrocarbylene group, further an alkylene-O-alkylene group;
iii) a (CH₂)m-OC(O)-hydrocarbylene-OC(O)—(CH₂)m group, where each m is independently ≥0; further (CH₂)m-OC(O)-alkylene-OC(O)—(CH₂)m group, each m is independently ≥0;
iv) a (CH₂)m-O-hydrocarbylene-O—(CH₂)m group, where each m is independently ≥0;
further a (CH₂)m-O-alkylene-O—(CH₂)m group, where each m is independently ≥0; or v) a hydrocarbylene-Si(X¹)(X²)—O—Si(X³)(X⁴)-hydrocarbylene, where X¹, X², X³ and X⁴ are each independently an alkyl group, and further X1=X2=X3=X⁴; further an alkylene-Si(X¹)(X²)—O—Si(X³)(X⁴)-alkylene, where X¹, X², X³ and X⁴ are each independently an alkyl group, and further X1=X2=X3=X⁴;
each Z (from C to Z to epoxy) is independently an O. S, SO₂, a hydrocarbylene group (for example, CH₂), or an O-hydrocarbylene group, further an O, an alkylene group, or an O-alkylene group; each n is independently ≥0, and further each n is the same;

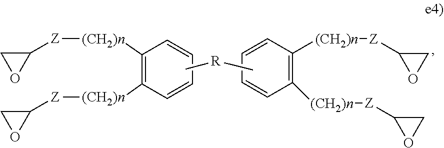

where R is selected from the following:
i) a hydrocarbylene group, further an alkylene group;
ii) a hydrocarbylene-O-hydrocarbylene group, further an alkylene-O-alkylene group;
iii) a (CH₂)m-OC(O)-hydrocarbylene-OC(O)—(CH₂)m group, where each m is independently ≥0, and further a (CH₂)m-OC(O)-alkylene-OC(O)—(CH₂)m group, where each m is independently ≥0;
iv) a (CH₂)m-O-hydrocarbylene-O—(CH₂)m group, where each m is independently ≥0, and further a (CH₂)m-O-alkylene-O—(CH₂)m group, where each m is independently ≥0; or
v) a hydrocarbylene-Si(X¹)(X²)—O—Si(X³)(X⁴)-hydrocarbylene, where X¹, X², X³ and X⁴ are each independently an alkyl group, and further X1=X2=X3=X⁴; and further an alkylene-Si(X¹)(X²)—O—Si(X³)(X⁴)-alkylene, where X¹, X², X³ and X⁴ are each independently an alkyl group, and further X1=X2=X3=X⁴;
   each Z (from C to Z to epoxy) is independently an O, S. SO₂, a hydrocarbylene group, or a O-hydrocarbylene group, further an O), an alkylene group, or an O-alkylene group; each n is independently ≥0, and further each n is the same;

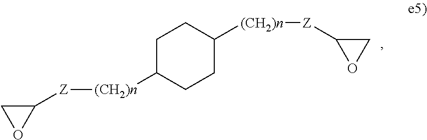

wherein each Z (from C to Z to epoxy) is independently an O, S. SO₂, a hydrocarbylene group, or an O-hydrocarbylene group, and further each Z is the same; and further an O, an alkylene group, or an O-alkylene group, and further each Z is the same; each n is independently ≥0, and further each n is the same;

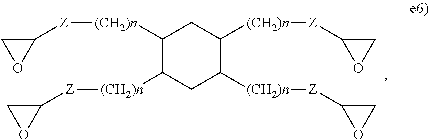

wherein each Z (from C to Z to epoxy) is independently an O, S, SO₂, a hydrocarbylene group, or an O-hydrocarbylene group, and further each Z is the same; and further an O, an alkylene group, or an O-alkylene group, and further each Z is the same; each n is independently ≥0, and further each n is the same;

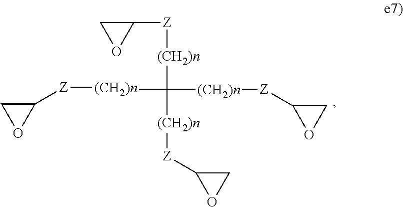

wherein each Z (from C to Z to epoxy) is independently an O, S, SO₂, a hydrocarbylene group, or a O-hydrocarbylene group, and further each Z is the same; and further an O, an alkylene group, or an O-alkylene group, and further each Z is the same; each n is independently ≥0, and further each n is the same;

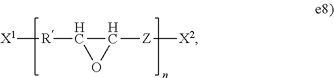

wherein Z (from C to Z to R′) is a hydrocarbylene-CH═CH-hydrocarbylene-CR″(CH═CH₂) group, where R″ is H or an alkyl group, and further H; and further an alkylene-CH—CH-alkylene-CR″(CH—CH₂) group, where R″ is H or an alkyl group, and further H;
R′ is a hydrocarbylene group, further an alkylene group; X¹ is OH or an alkyl group, and further OH; X² is OH or an alkyl group, and further OH; and n≥1.

Note, X1=X¹, X2=X², X3=X³ etc., as used in structures e1), e3) and e4).

Note, for each noted group of each of structures e1) to e8), each hydrocarbylene may be the same or different, and each alkylene may be the same or different.
F] The process of any one of A]-E] above, wherein the at least one oxetane compound of component b is selected from one of structures o1) to o4) below:

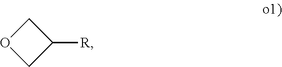

wherein R is selected from a hydrocarbyl group, a hydrocarbylene-O-hydrocarbyl group, or a hydrocarbylene-O—C(O)-hydrocarbyl group, further an alkyl group, an alkylene-O-alkyl group, or an alkylene-O—C(O)-alkyl group;

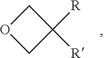

wherein R is selected from a hydrocarbyl group, a hydrocarbylene-O-hydrocarbyl group, or a hydrocarbylene-O—C(O)-hydrocarbyl group, further an alkyl group, an alkylene-O-alkyl group, or an alkylene-O—C(O)-alkyl group, and R′ is a hydrocarbyl group, further an alkyl group;

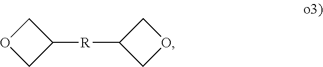

wherein R is selected from a hydrocarbylene group, a hydrocarbylene-O-hydrocarbylene group, a hydrocarbylene-O—C(O)-hydrocarbylene group, and further an alkylene group, an alkylene-O-alkylene group, or an alkylene-O—C(O)-alkylene group;

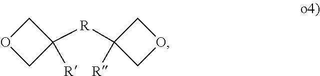

wherein R is selected from a hydrocarbylene group, a hydrocarbylene-O-hydrocarbylene group, a hydrocarbylene-O—C(O)-hydrocarbylene group, and further an alkylene group, an alkylene-O-alkylene group, or an alkylene-O—C(O)— alkylene group; and R′ is a hydrocarbyl group, further an alkyl group, and R″ is a hydrocarbyl group, further an alkyl group, and further R′═R″.

Note, for each noted group of each of structures o1) to o4), each hydrocarbylene may the same or different, and each alkylene may be the same or different.

Note, for each noted group of each of structures o1) to o4), each hydrocarbyl may the same or different, and each alkyl may be the same or different.
G] The process of any one of A]-F] above, wherein the multifunctional epoxy compound is selected from structures e11), e12), e21), e31), e41), e51), e71) or 81) below; and the oxetane compound is selected from 041) below:

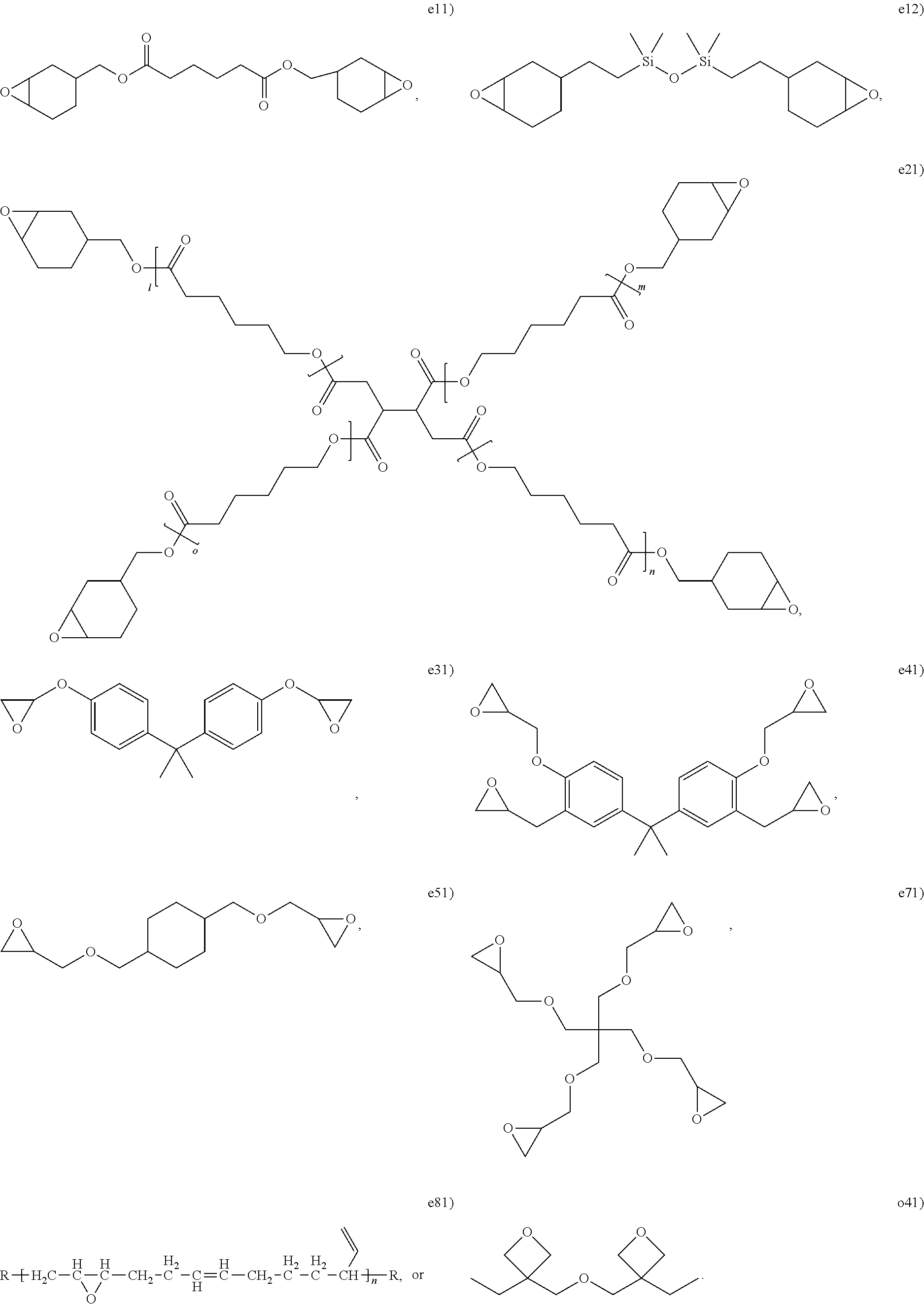

H] The process of any one of A]-G] above, wherein step B takes place at a temperature ≥20° C., or ≥21° C., or ≥22° C., or ≥24° C., or ≥26° C., or ≥28° C., or ≥30° C., or ≥32° C., or ≥ 34° C., and/or ≤100° C., or ≤95° C., or ≤90° C., or ≤88° C., or ≤86° C., or ≤85° C., or ≤80° C., or ≤75° C., or ≤70° C., or ≤65° C., or ≤60° C., or ≤55° C., or ≤50° C., or ≤45° C., or ≤40° C.
I] The process of any one of A]-H] above, wherein step B takes place at a temperature ≥20° C., or ≥30° C., or ≥40° C., or ≥50° C., or ≥60° C., or ≥70° C., or ≥80° C., and/or ≤150° C., or ≤140° C., or ≤130° C., or ≤120° C., or ≤110° C., or ≤100° C., or ≤90° C.
J] The process of any one of A]-I] above, wherein step B takes place at a percent relative humidity (% RH)≥40%, or ≥42%, or ≥44%, or ≥46%, or ≥48%, or ≥50%, and/or ≤ 100%, or ≤95%, or ≤90%, or ≤88%, or ≤86%, or ≤85%.
K] The process of any one of A]-J] above, wherein the composition comprises a crosslinked ethylene-based polymer, further a crosslinked ethylene/alpha-olefin interpolymer, and further a crosslinked ethylene/alpha-olefin copolymer.
L] The process of any one of A]-J] above, wherein the composition comprises a crosslinked propylene-based polymer further a crosslinked propylene/ethylene interpolymer or a crosslinked propylene/alpha-olefin interpolymer, and further a crosslinked propylene/ethylene copolymer or a crosslinked propylene/alpha-olefin copolymer.
M] A crosslinked composition formed from the process of any one of A]-L] above.
A2] A first composition comprising at least the following components a and b:
   a) an “anhydride-functionalized olefin-based polymer;”
   b) at least one multifunctional epoxy compound comprising at least two epoxy groups, or at least one oxetane compound comprising at least one oxetane group.
B2] The first composition of A2] above, wherein the molar ratio of the epoxy groups on the multifunctional epoxy compound or the oxetane groups on the oxetane compound to the anhydride groups on the “anhydride-functionalized olefin-based polymer” is ≥0.20, or ≥0.40, or ≥0.60, or ≥0.80, or ≥0.85, or ≥0.90, or ≥0.95, or ≥1.00, and/or ≤5.00, or ≤4.50, or ≤4.00, or ≤3.50, or ≤3.00, or ≤2.50, or ≤2.00, or ≤1.90, or ≤1.80, or ≤1.70, or ≤1.60, or ≤1.50, or ≤1.40, or ≤1.35
C2] The first composition of A2] or B2] above, wherein the at least one multifunctional epoxy compound of component b is selected from one of structures e1) to e8), each described above (see E]).
D2] The first composition of any one of A2]-C2] above, wherein the at least one oxetane compound of component b is selected from one of structures o1) to o4), each described above (see F]).
E2] The first composition of any one of A2]-D2] above, wherein the multifunctional epoxy compound is selected from structures e11), e12), e21), e31), e41), e51), e71) or 81), each described above (see G]); and the oxetane compound is selected from 041) described above (see G]).
F2] A crosslinked composition formed from the first composition of any one of A2]-E2] above.
A3] The process of any one of A]-L] above, or the first composition of any one of A2]-E2] above, or the crosslinked composition of M] or F2] above, wherein for structure e1), R is selected from the following: iii) a (CH₂)n-OC(O)-alkylene-OC(O)—(CH₂)n group, where each n is independently ≥1, further from 1 to 10, or 1 to 8, or 1 to 6, or 1 to 3, or v) an alkylene-Si(X¹)(X²)—O—Si(X³)(X⁴)-alkylene, where X¹, X², X³ and X⁴ are each independently an alkyl group, and further X1=X2=X3=X⁴; and
   for structure e2), each B is independently an O-alkylene-C(O) group; each Z is independently an O-alkylene group; n=0 to 20, or 0 to 10, or 0 to 8, or 0 to 6, or 0 to 3, or 0 to 2, or 0 to 1, or 0; and each of l, m, o, p, independently, =0 to 20, or 0 to 10, or 0 to 8, or 0 to 6, or 0 to 3, or 0 to 2, or 0 or 1, and further 1+m+o+p=1;
   for structure e3), R is an alkylene, and further a C1-C5 alkylene, or a C1-C4 alkylene, or a C1-C3 alkylene, or a C2-C3 alkylene; and n=0 to 20, or 0 to 10, or 0 to 8, or 0 to 6, or 0 to 3, or 0 to 2, or 0 or 1, or 0; and Z=O;
   for structure e4), each Z is independently an alkylene group, or an O-alkylene group; R is an alkylene, and further a C1-C5 alkylene, or a C1-C4 alkylene, or a C1-C3 alkylene, or a C2-C3 alkylene; and n=0 to 20, or 0 to 10, or 0 to 8, or 0 to 6, or 0 to 3, or 0 to 2, or 0;
   for structure e5), each Z is independently an alkylene group, or an O-alkylene group, and further an O-alkylene group; and each n is independently=0 to 20, or 0 to 10, or 0 to 8, or 0 to 6, or 0 to 3, or 0 to 2, or 0 or 1, or 1;
   for structure e6), each Z is independently an alkylene group, or an O-alkylene group, and further an O-alkylene group; and each n is independently=0 to 20, or 0 to 10, or 0 to 8, or 0 to 6, or 0 to 3, or 0 to 2, or 0 or 1, or 1;
   for structure e7), each Z is independently an alkylene group, or an O-alkylene group, and further an O-alkylene group; and each n is independently=0 to 20, or 0 to 10, or 0 to 8, or 0 to 6, or 0 to 3, or 0 to 2, or 0 or 1, or 1;
   for structure e8), n=1 to 100, or 1 to 50, or 1 to 20, or 1 to 10, or 1 to 8, or 1 to 6, or 1 or 1, or 1 or 2.
B3] The process of any one of A]-L] or A3] above, or the first composition of any one of A2]-E2] or A3] above, or the crosslinked composition of any one of M], F2] or A3] above, wherein for structure o1), R is selected from an alkyl group, or an alkylene-O-alkyl group, and further an alkyl group;
   for structure o2), R is selected from an alkyl group, or an alkylene-O-alkyl group, and further an alkyl group; and R′ is a C1-C5 alkyl, or a C1-C4 alkyl, or a C1-C3 alkyl, or a C1-C2 alkyl;
   for structure o3), R is selected from an alkylene group, or an alkylene-O)-alkylene group, and further an alkylene-O-alkylene group;
   for structure o4), R is selected from an alkylene group, or an alkylene-O-alkylene group, and further an alkylene-O-alkylene group; R′ is a C1-C5 alkyl, or a C1-C4 alkyl, or a C1-C3 alkyl, or a C1-C2 alkyl; and R″ is a C1-C5 alkyl, or a C1-C4 alkyl, or a C1-C3 alkyl, or a C1-C2 alkyl, and further R′═R″.
C3] The process of any one of A]-L], A3] or B3] above, or the first composition of any one of A2]-E2], A3] or B3] above, or the crosslinked composition of any one of M], F2], A3] or B3] above, wherein component b is at least one multifunctional epoxy compound, and further one multifunctional epoxy compound.
D3] The process of any one of A]-L] or A3], or B3] above, or the first composition of any one of A2]-E2] or A3], or B3] above, or the crosslinked composition of any one of M], F2] or A3], or B3] above, wherein component b is at least one oxetane compound, and further one oxetane compound.
E3] The process of any one of A]-L] or A3]-D3] above, or the first composition of any one of A2]-E2] or A3]-D3] above, or the crosslinked composition of any one of M], F2] or A3]-D3] above, wherein component a is an anhydride-functionalized ethylene-based polymer, and furthers an anhydride-functionalized ethylene/alpha-olefin interpolymer, and further an anhydride-functionalized ethylene/alpha-olefin copolymer.
F3] The process of any one of A]-L] or A3]-E3] above, or the first composition of any one of A2]-E2] or A3]-E3] above, or the crosslinked composition of any one of M], F2] or A3]-E3] above, wherein component a is an anhydride grafted ethylene-based polymer, further a grafted anhydride ethylene/alpha-olefin interpolymer, and further an anhydride grafted ethylene/alpha-olefin copolymer.
G3] The process of E3] or F3] above, or the first composition of E3] or F3] above, or the crosslinked composition of any one of E3] or F3] above, wherein the alpha-olefin is a C3-C20 alpha-olefin, and further a C3-C10 alpha-olefin, and further propylene, 1-butene, 1-pentene, 1-hexene or 1-octene, and further propylene, 1-butene, 1-hexene or 1-octene, and further propylene, 1-butene or 1-octene, further 1-butene or 1-octene, and further 1-octene.
H3] The process of E3], F3] or G3] above, or the first composition of E3], F3] or G3] above, or the crosslinked composition of any one of E3], F3] or G3] above, wherein the anhydride of the anhydride-functionalized ethylene-based polymer is derived from maleic anhydride.

I3] The process of any one of A]-L] or A3]-D3] above, or the first composition of any one of A2]-E2] or A3]-D3] above, or the crosslinked composition of any one of M], F2] or A3]-D3] above, wherein component a is an anhydride-functionalized propylene-based polymer, and furthers an anhydride-functionalized propylene/ethylene interpolymer or an anhydride-functionalized propylene/alpha-olefin interpolymer, and further an anhydride-functionalized propylene/ethylene copolymer or an anhydride-functionalized propylene/alpha-olefin copolymer.
J3] The process of any one of A]-L], A3]-D3] or I3] above, or the first composition of any one of A2]-E2], A3]-D3] or I3] above, or the crosslinked composition of any one of M], F2], A3]-D3] or I3] above, wherein component a is an anhydride-grafted propylene-based polymer, and furthers an anhydride-grafted propylene/ethylene interpolymer or an anhydride-grafted propylene/alpha-olefin interpolymer, and further an anhydride-grafted propylene/ethylene copolymer or an anhydride-grafted propylene/alpha-olefin copolymer.
K3] The process of I3] or J3] above, or the first composition of 13] or J3] above, or the crosslinked composition of 13] or J3] above, wherein the alpha-olefin is a C4-C20 alpha-olefin, and further a C4-C10 alpha-olefin, and 1-butene, 1-pentene, 1-hexene or 1-octene, and further 1-butene, 1-hexene or 1-octene, and further 1-butene or 1-octene, and further 1-octene.
L3] The process of I3], J3] or K3] above, or the first composition of 13], J3] or K3] above, or the crosslinked composition of 13], J3] or K3] above, wherein the anhydride of the anhydride-functionalized propylene-based polymer is derived from maleic anhydride.
M3] The process of any one of A]-L] or A3]-L3] above, or the first composition of any one of A2]-E2] or A3]-L3] above, or the crosslinked composition of any one of M], F2] or A3]-L3] above, wherein component a has a density ≥0.860 g/cc, or ≥0.862 g/cc, or ≥0.864 g/cc, or ≥0.866 g/cc, or ≥0.868 g/cc, or ≥0.870 g/cc, or ≥0.872, or ≥0.874 g/cc, or ≥0.876 g/cc, or ≥0.877 g/cc, and/or ≤0.920 g/cc, or ≤0.915 g/cc, or ≤0.910 g/cc, or ≤0.905 g/cc, or ≤0.900 g/cc, or ≤0.890 g/cc, or ≤0.888 g/cc, or ≤0.886 g/cc, or ≤0.884 g/cc, or ≤0.882 g/cc, or ≤0.880 g/cc, or ≤0.879 g/cc (1 cc=1 cm³).
N3] The process of any one of A]-L] or A3]-M3] above, or the first composition of any one of A2]-E2] or A3]-M3] above, or the crosslinked composition of any one of M], F2] or A3]-M3] above, wherein component a has a melt viscosity (177° C.)≤100,000 mPa·s, or ≤ 90,000 mPa s, or ≤80,000 mPa s, or ≤70,000 mPa's, or ≤60,000 mPa's, or ≤50,000 mPa s, or ≤45,000 mPa s, or ≤40,000 mPa·s, or ≤35,000 mPa·s, or ≤30,000 mPa s, or ≤25,000 mPa·s, or ≤22,000 mPa·s, or ≤20,000 mPa·s, or ≤18,000 mPa·s, or ≤ 16,000 mPa·s, or ≤ 14,000 mPa s, and/or ≥2,000 mPa·s, or ≥3,000 mPa's, or ≥4,000 mPa·s, or ≥5,000 mPa·s, or ≥6,000 mPa·s, or ≥8,000 mPa·s, or ≥10,000 mPa s, or ≥12,000 mPa·s.
O3] The process of any one of A]-L] or A3]-N3] above, or the first composition of any one of A2]-E2] or A3]-N3] above, or the crosslinked composition of any one of M], F2] or A3]-N3] above, wherein component a has a melt index (12)≥5.0, or ≥10, or ≥20, or ≥50, or ≥100, or ≥200, or ≥300, or ≥400, or ≥500, or ≥550 dg/min, and/or ≤2,000, or ≤1,500, or ≤1,000, or ≤900, or ≤800, or ≤700 dg/min.
P3] The process of any one of A]-L] or A3]-03] above, or the first composition of any one of A2]-E2] or A3]-03] above, or the crosslinked composition of any one of M], F2] or A3]-03] above, wherein component a has a melting point (Tm)≥50° C., or ≥55° C., or ≥ 60° C., or ≥62° C., or ≥64° C., or ≥66° C., or ≥68° C., or ≥70° C., or ≥75° C., or ≥80° C., or ≥85° C., and/or ≤150° C., or ≤145° C., or ≤140° C., or ≤138° C., or ≤136° C., or ≤134° C., or ≤ 132° C., or ≤130° C., or ≤125° C., or ≤120° C., or ≤115° C., or ≤110° C., or ≤105° C., or ≤100° C.
Q3] The process of any one of A]-L] or A3]-P3] above, or the first composition of any one of A2]-E2] or A3]-P3] above, or the crosslinked composition of any one of M], F2] or A3]-P3] above, wherein component a has a percent crystallinity ≥10%, or ≥12%, or ≥14%, or ≥16%, or ≥18%, or ≥19%, and/or ≤80%, or ≤70%, or ≤60%, or ≤50%, or ≤40%, or ≤35%, or ≤30%, or ≤28%, or ≤26%, or ≤24%, or ≤22%, or ≤21%.
R3] The process of any one of A]-L] or A3]-Q3] above, or the first composition of any one of A2]-E2] or A3]-Q3] above, or the crosslinked composition of any one of M], F2] or A3]-Q3] above, wherein component a has a number average molecular weight Mn≥6,000, or ≥8,000, or ≥10,000, or ≥12,000, and/or ≤70,000, or ≤60,000, or ≤50,000, or ≤40,000, or ≤30,000, or ≤28,000, or ≤26,000, or ≤24,000, or ≤22,000, or ≤20,000, or ≤18,000 g/mol.
S3] The process of any one of A]-L] or A3]-R3] above, or the first composition of any one of A2]-E2] or A3]-R3] above, or the crosslinked composition of any one of M], F2] or A3]-R3] above, wherein component a has a molecular weight distribution (Mw/Mn)≥2.00, or ≥2.10, or ≥2.20, or ≥2.30, or ≥2.40 g/mol, and/or ≤3.50, or ≤3.40, or ≤3.30, or ≤3.20, or ≤3.10, or ≤3.00, or ≤2.90, or ≤2.80, or ≤2.70, or ≤2.60, or ≤2.50.
T3] The process of any one of A]-L] or A3]-S3] above, or the first composition of any one of A2]-E2] or A3]-S3] above, or the crosslinked composition of any one of M], F2] or A3]-S3] above, wherein component a comprises ≥0.1 wt %, or ≥0.2 wt %, or ≥0.3 wt %, or ≥0.4 wt %, or ≥0.5 wt %, or ≥0.6 wt %, or ≥0.7 wt %, or ≥0.8 wt %, or ≥0.9 wt %, or ≥1.0 wt %, or ≥1.1 wt %, and/or ≤20 wt %, or ≤15 wt %, or ≤10 wt %, or ≤5.0 wt %, or ≤4.0 wt %, or ≤ 3.5 wt %, or ≤3.0 wt %, or ≤2.5 wt %, or ≤2.0 wt %, or ≤1.8 wt %, or ≤1.6 wt % of anhydride groups, based on the weight of the anhydride-functionalized olefin-based polymer.
U3] The process of any one of A]-L] or A3]-T3] above, or the first composition of any one of A2]-E2] or A3]-T3] above, or the crosslinked composition of any one of M], F2] or A3]-T3] above, wherein the weight ratio of component a to component b is ≥20, or ≥22, or ≥24, or ≥26, or ≥28, or ≥30, or ≥32, and/or ≤90, or ≤88, or ≤86, or ≤84, or ≤82, or ≤80, or ≤78, or ≤76, or ≤74, or ≤72, or ≤70.
V3] The process of any one of A]-L] or A3]-U3] above, or the first composition of any one of A2]-E2] or A3]-U3] above, or the crosslinked composition of any one of M], F2] or A3]-U3] above, wherein component b has a molecular weight ≥10, or ≥20, or ≥50, or ≥100 g/mole, and/or ≤5,000, or ≤2.000, or ≤1.000, or ≤800, or ≤600, or ≤400 g/mole.
W3] The process of any one of A]-L] or A3]-V3] above, or the first composition of any one of A2]-E2] or A3]-V3] above, or the crosslinked composition of any one of M], F2] or A3]-V3] above, wherein component b does not comprise a —C(O)OH group nor a —C(O)O— group, and further does not comprise a —C(O)OH group.
X3] The process of any one of A]-L] or A3]-W3] above, or the first composition of any one of A2]-E2] or A3]-W3] above, or the crosslinked composition of any one of M], F2] or A3]-W3] above, wherein the first composition further comprises a tackifier (component c).
Y3] The process of X3] above, or the first composition of X3] above, or the crosslinked composition of X3] above, wherein the weight ratio of component a to component c is ≥1.00, or ≥1.20, or ≥1.40, or ≥1.60, or ≥1.80, or ≥2.00, or ≥2.10, or ≥2.20, and/or ≤3.00, or ≤2.80, or ≤2.60, or ≤2.50, or ≤2.40, or ≤2.35.
Z3] The process of X3] or Y3] above, or the first composition of any one of X3] or Y3] above, or the crosslinked composition of any one of X3] or Y3] above, wherein component c is a hydrocarbon resin, further a hydrogenated hydrocarbon resin.
A4] The process of any one of A]-L] or A3]-Z3] above, or the first composition of any one of A2]-E2] or A3]-Z3] above, or the crosslinked composition of any one of M], F2] or A3]-Z3] above, wherein the composition comprises ≥15 wt %, or ≥20 wt %, or ≥30 wt %, or ≥40 wt %, or ≥50 wt %, or ≥55 wt %, or ≥60 wt %, or ≥62 wt %, or ≥65 wt %, and/or ≤95 wt %, or ≤90 wt %, or ≤85 wt %, or ≤80 wt %, or ≤75 wt %, or ≤72 wt %, or ≤70 wt % of the component a, based on the weight of the composition.
B4] The process of any one of A]-L] or A3]-A4] above, or the first composition of any one of A2]-E2] or A3]-A4] above, or the crosslinked composition of any one of M], F2] or A3]-A4] above, wherein the composition comprises ≥0.70, or ≥0.72, or ≥0.75, or ≥0.77, or ≥0.80, or ≥0.82, or ≥0.85, or ≥0.87, or ≥0.90 wt % and/or ≤4.00, or ≤3.50, or ≤3.00, or ≤2.80, or ≤2.60, or ≤2.55, or ≤2.50, or ≤2.45 wt % of the component b, based on the weight of the composition.
C4] The process of any one of A]-L] or A3]-B4] above, or the first composition of any one of A2]-E2] or A3]-B4] above, or the crosslinked composition of any one of M], F2] or A3]-B4] above, wherein the first composition comprises ≥80.0 wt %, or ≥90.0 wt %, or ≥ 92.0 wt %, or ≥94.0 wt %, or ≥96.0 wt %, or ≥98.0 wt %, or ≥99.0 wt %, or ≥99.2 wt %, or ≥99.5 wt % and/or ≤100.0 wt %, or ≤99.9 wt %, ≤99.8 wt %, or ≤99.7 wt %, or ≤99.6 wt % of the sum of components a, b and c, based on the weight of the composition.
D4] The process of any one of A]-L] or A3]-C4] above, or the first composition of any one of A2]-E2] or A3]-C4] above, or the crosslinked composition of any one of M], F2] or A3]-C4] above, wherein the first composition has a melt viscosity (η1), after 1 hour at 140° C., ≥20,000, or ≥25,000, or ≥30,000, or ≥35,000, or ≥40,000, or ≥45,000 mPa·s, and/or ≤80,000, or ≤75,000, or ≤70,000, or ≤68,000 mPa·s.
E4] The process of any one of A]-L] or A3]-D4] above, or the first composition of any one of A2]-E2] or A3]-D4] above, or the crosslinked composition of any one of M], F2] or A3]-D4] above, wherein the first composition has a percent increase in melt viscosity after 2 hours at 140° C. (% Δη2 at 140° C.)≤50%, or ≤45%, or ≤40%, or ≤38%, or ≤36%, and/or ≥5.0%, or ≥10.0%, or ≥15.0%, or ≥20%, or ≥25%.
F4] The process of any one of A]-L] or A3]-E4] above, or the first composition of any one of A2]-E2] or A3]-E4] above, or the crosslinked composition of any one of M], F2] or A3]-E4] above, wherein the first composition has a melt viscosity (η1), after 1 hour at 177° C., ≥1,000, or ≥2,000, or ≥4,000, or ≥6,000 mPa·s, and/or ≤20,000, or ≤15,000, or ≤10,000 mPa·s.
G4] The process of any one of A]-L] or A3]-F4] above, or the first composition of any one of A2]-E2] or A3]-F4] above, or the crosslinked composition of any one of M], F2] or A3]-F4] above, wherein the first composition has a percent increase in melt viscosity after 2 hours at 177° C. (% Δη2 at 177° C.)≤30%, or ≤25%, or ≤20%, and/or ≥1.0%, or ≥2.0%, or ≥3.0%, or ≥4.0%, or ≥5.0%.
H4] The process of any one of A]-L] or A3]-G4] above, or the first composition of any one of A2]-E2] or A3]-G4] above, or the crosslinked composition of any one of M], F2] or A3]-G4] above, wherein the first composition has a percent increase in melt viscosity after 3 hours at 177° C. (% Δη3 at 177° C.)≤65%, or ≤60%, or ≤55%, and/or ≥8.0%, or ≥10%, or ≥ 12%, or ≥14%, or ≥16%.
[4] The process of any one of A]-L] or A3]-H4] above, or the first composition of any one of A2]-E2] or A3]-H4] above, or the crosslinked composition of any one of M], F2] or A3]-H4] above, wherein the first composition, after seven days at 22° C., 50% RH, in air atmosphere, has SAFT value ≥70° C., or ≥72° C., or ≥74° C., or ≥76° C., or ≥78° C., or ≥79° C., or ≥81° C., or ≥82° C., or ≥83° C. and/or ≤170° C., or ≤165° C., or ≤160° C., or ≤155° C., or ≤ 150° C., or ≤145° C., or ≤140° C., or ≤135° C., or ≤130° C., or ≤125° C., or ≤120° C.
J4] The process of any one of A]-L] or A3]-14] above, or the first composition of any one of A2]-E2] or A3]-[4] above, or the crosslinked composition of any one of M], F2] or A3]-14] above, wherein the first composition, after seven days at 35° C., 85% RH, in air, has SAFT value ≥75° C., or ≥78° C., or ≥80° C., or ≥82° C., or ≥84° C., or ≥86° C., or ≥88° C., or ≥90° C., or ≥92° C., or ≥94° C., or ≥96° C., or ≥98° C., or ≥100° C. and/or ≤200° C., or ≤190° C., or ≤ 185° C., or ≤180° C., or ≤175° C., or ≤170° C.
K4] The process of any one of A]-L] or A3]-J4] above, or the first composition of any one of A2]-E2] or A3]-J4] above, or the crosslinked composition of any one of M], F2] or A3]-J4] above, wherein the first composition, after seven days at 85° C., 85% RH, in air, has SAFT value ≥100° C., or ≥115° C., or ≥120° C., or ≥125° C., or ≥130° C. and/or ≤200° C., or ≤190° C., or ≤185° C., or ≤180° C., or ≤175° C., or ≤170° C.
L4] The process of any one of A]-L] or A3]-K4] above, or the first composition of any one of A2]-E2] or A3]-K4] above, or the crosslinked composition of any one of M], F2] or A3]-K4] above, wherein the first composition further comprises at least one additive, and further at least one antioxidant.
M4] The process of any one of A]-L] or A3]-L4] above, or the first composition of any one of A2]-E2] or A3]-L4] above, or the crosslinked composition of any one of M], F2] or A3]-L4] above, wherein the first composition further comprises a polymer, different from component a in one or more features, such as monomer(s) types, monomer distributions, melt viscosity (177° C.), density, or any combination thereof.
N4] The process of any one of A]-L] or A3]-M4] above, or the first composition of any one of A2]-E2] or A3]-M4] above, or the crosslinked composition of any one of M], F2] or A3]-M4] above, wherein the first composition comprises ≤0.50 ppm, or ≤0.20 ppm, or ≤ 0.10 ppm, or ≤0.05 ppm, or ≤0.02 ppm, or ≤0.01 ppm of a peroxide, and further the first composition does not comprise a peroxide.
O4] The process of any one of A]-L] or A3]-N4] above, or the first composition of any one of A2]-E2] or A3]-N4] above, or the crosslinked composition of any one of M], F2] or A3]-N4] above, wherein the crosslinked composition comprises at least one structure selected from: i) one of structures CL1, CL2, CL3 or any combination thereof, or ii) one of structures CL4, CL5, CL6 or any combination thereof; and each structure is shown below:

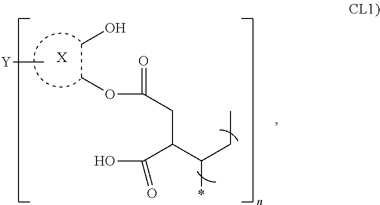

wherein Y is derived from a multifunctional epoxy compound;
   X is the remaining portion of a C3 to C8, or a C4 to C7, or a C5 to C6 ring structure, which contains a carbon atom that is bonded to Y, or X is not present, and Y is bonded to the terminal carbon atom of a “—CH(OH)—CH₂—O—” bridge;
   n=2 to 600, or 2 to 300, or 2 to 100, or 2 to 50, or 2 to 20, or 2 to 10, or 2 to 4; each asterisk (*) independently represents a portion of the respective remaining polymer chain bonded to the respective end of the —CH2-CHZ— group noted above, where Z is the pendant crosslinked site as noted above;

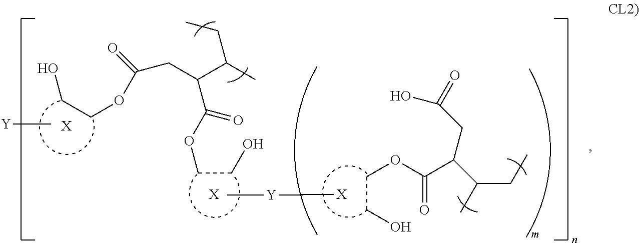

wherein each Y is independently derived from a multifunctional epoxy compound; each X is independently the remaining portion of a C3 to C8, or a C4 to C7, or a C5 to C6 ring structure, which contains a carbon atom that is bonded to Y, or X is not present, and Y is bonded to the terminal carbon atom of a “—CH(OH)—CH₂—O—” bridge;
n=2 to 600, or 2 to 300, or 2 to 100, or 2 to 50, or 2 to 20, or 2 to 10, or 2 to 4; m=2 to 600, or 2 to 300, or 2 to 100, or 2 to 50, or 2 to 20, or 2 to 10, or 2 to 4; each asterisk (*) independently represents a portion of the respective remaining polymer chain bonded to the respective end of the respective —CH2-CHZ— group noted above, where Z is one of the pendant crosslinked sites as noted above;

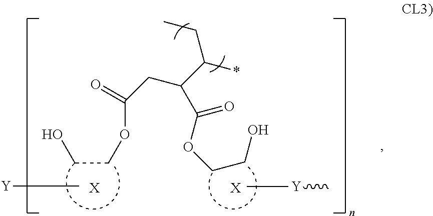

wherein each Y is independently derived from a multifunctional epoxy compound; each X is independently the remaining portion of a C3 to C8, or a C4 to C7, or a C5 to C6 ring structure, which contains a carbon atom that is bonded to Y, or X is not present, and Y is bonded to the terminal carbon atom of a “—CH(OH)—CH₂—O—” bridge; n=2 to 600, or 2 to 300, or 2 to 100, or 2 to 50, or 2 to 20, or 2 to 10, or 2 to 4; each asterisk (*) independently represents a portion of the respective remaining polymer chain bonded to the respective end of the —CH2-CHZ— group noted above, where Z is the pendant crosslinked site as noted above; the “ [symbol] ” notation independently represents another —CH2-CHZ— group;

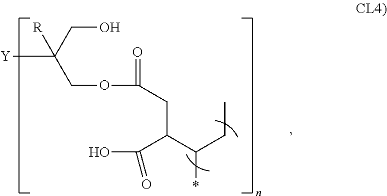

wherein Y is derived from a oxetane compound;
R is H or a hydrocarbyl group, and further H or a C1-C20 hydrocarbyl group;
n=2 to 600, or 2 to 300, or 2 to 100, or 2 to 50, or 2 to 20, or 2 to 10, or 2 to 4; each asterisk (*) independently represents a portion of the respective remaining polymer chain bonded to the respective end of the —CH2-CHZ— group noted above, where Z is the pendant crosslinked site as noted above;

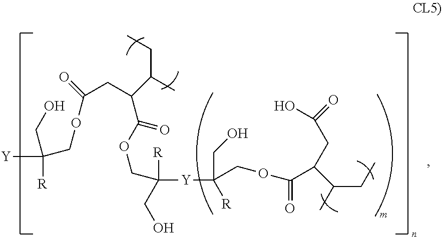

wherein each Y is independently derived from a oxetane compound; each R is independently H or a hydrocarbyl group, and further H or a C1-C20 hydrocarbyl group;
n=2 to 600, or 2 to 300, or 2 to 100, or 2 to 50, or 2 to 20, or 2 to 10, or 2 to 4; m=2 to 600, or 2 to 300, or 2 to 100, or 2 to 50, or 2 to 20, or 2 to 10, or 2 to 4; each asterisk (*) independently represents a portion of the respective remaining polymer chain bonded to the respective end of the respective —CH2-CHZ— group noted above, where Z is one of the pendant crosslinked sites as noted above;

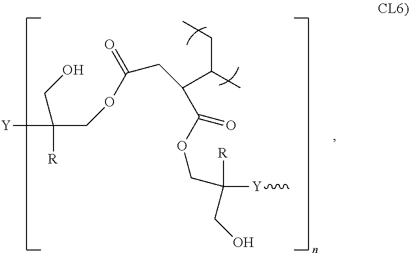

wherein each Y is independently derived from a oxetane compound; each R is independently H or a hydrocarbyl group, and further H or a C1-C20 hydrocarbyl group;
n=2 to 600, or 2 to 300, or 2 to 100, or 2 to 50, or 2 to 20, or 2 to 10, or 2 to 4; each asterisk (*) independently represents a portion of the respective remaining polymer chain bonded to the respective end of the —CH2-CHZ— group noted above, where Z is the pendant crosslinked site as noted above; the “ [symbol] ” notation independently represents another —CH2-CHZ— group.
P4] A crosslinked composition comprises at least one structure selected from the following: i) one of structures CL1, CL2, CL3 or any combination thereof, or ii) one of structures CL4, CL5, CL6 or any combination thereof, and wherein each structure is shown above (see O4]).
Q4] The first composition of any one of A2]-E2], or A3]-04] above, wherein the first composition is an adhesive, and further a hot melt adhesive.
R4] An article comprising at least one component comprising the first composition of any one of A2]-E2], A3]-04] or Q4] above, or the crosslinked composition of any one of M], F2], or A3]-P4] above.
S4] An article comprising at least one component formed from the first composition of any one of A2]-E2], A3]-04], or Q4] above, or the crosslinked composition of any one of M],
F2], or A3]-P4] above.
T4] The article of R4] or S4] above, wherein the composition adheres together two surfaces of the article.
U4] The article of R4] or S4] above, wherein the article is furniture, a book or a container.

### Test Methods

### Melt Viscosity of Polymer and First Composition

Melt viscosity was measured in accordance with ASTM D 3236, using a Brookfield Viscometer (Model DVOIII, version 3), and a SC-31 hot-melt viscometer spindle, at the following temperatures: a) 177° C. for the anhydride functionalized olefin-based polymer (component a); and b) 120° C., 140° C., 150° C. or 177° C. for the first composition (50% RH). This method can also be used to measure the melt viscosity of the tackifier (at 160° C.). The sample was poured into an aluminum disposable tube-shaped chamber, which is, in turn, inserted into a Brookfield Thermosel, and locked into place. The sample chamber had a notch on the bottom that fits the bottom of the Brookfield Thermosel, to ensure that the chamber was not allowed to turn, when the spindle was inserted and spinning. The sample (approximately 8-10 grams) was heated to the required temperature, until the melted sample was one inch below the top of the sample chamber. The viscometer apparatus was lowered, and the spindle was submerged into the middle of the sample chamber, wherein the spindle did not touch the sides of the chamber. Lowering was continued, until the brackets on the viscometer aligned on the Thermosel. The viscometer was turned on, and set to operate at a steady shear rate, which led to a torque reading in the range of 40 to 60 percent of the total torque capacity, based on the rpm output of the viscometer. Readings were taken every minute, for 15 minutes, or until the values stabilized, at which point, a final reading was recorded.

### Differential Scanning Calorimetry (DSC)

Differential Scanning calorimetry (DSC), as discussed below, is used to measure Tm, Tc, Tg and crystallinity in ethylene-based (PE) samples and propylene-based (PP) samples, unless noted otherwise. Each sample (0.5 g) is compression molded into a film, at 25000 psi, 190° C., for 10-15 seconds. About 5 to 8 mg of film sample is weighed and placed in a DSC pan. The lid is crimped on the pan to ensure a closed atmosphere. The sample pan is placed in a DSC cell, and then heated, at a rate of approximately 10° C./min, to a temperature of 180° C. for PE (230° C. for PP). The sample is kept at this temperature for three minutes. Then the sample is cooled at a rate of 10° C./min to −90° C. for PE (−60° C. for PP), and kept isothermally at that temperature for three minutes. The sample is next heated at a rate of 10° C./min, until complete melting (second heat). Unless otherwise stated, melting point (Tm) and the glass transition temperature (Tg) of each polymer sample are determined from the second heat curve, and the crystallization temperature (Tc) is determined from the first cooling curve. The Tg and the respective peak temperature for the Tm are noted. The percent crystallinity can be calculated by dividing the heat of fusion (Hf), determined from the second heat curve, by a theoretical heat of fusion of 292 J/g for PE (165 J/g for PP), and multiplying this quantity by 100 (for example, % cryst.=(Hf/292 J/g)×100 (for PE)).

### Density

The density of a polymer is measured by preparing the polymer sample according to ASTM D 1928, and then measuring the density according to ASTM D792, Method B, within one hour of sample pressing.

### Gel Permeation Chromatography-Ethylene-Based Polymers

The chromatographic system consists of a PolymerChar GPC-IR (Valencia, Spain) high temperature GPC chromatograph, equipped with an internal infra-red detector (IR5). The autosampler oven compartment is set at 160° C., and the column compartment is set at 150° C. The columns are four AGILENT “Mixed A” 30 cm, 20-micron linear mixed-bed columns. The chromatographic solvent is 1,2,4-trichlorobenzene, which contains 200 ppm of butylated hydroxytoluene (BHT). The solvent source is nitrogen sparged. The injection volume is 200 microliters, and the flow rate is 1.0 milliliters/minute.

Calibration of the GPC column set is performed with 21 narrow molecular weight distribution polystyrene standards, with molecular weights ranging from 580 to 8,400,000 g/mol, and which are arranged in six “cocktail” mixtures, with at least a decade of separation between individual molecular weights. The standards are purchased from Agilent Technologies. The polystyrene standards are prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards are dissolved at 80° C., with gentle agitation, for 30 minutes. The polystyrene standard peak molecular weights are converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1), where M is the molecular weight, A has a value of 0.4315 and B is equal to 1.0.

A fifth order polynomial is used to fit the respective polyethylene-equivalent calibration points. A small adjustment to A (from approximately 0.375 to 0.445) is made to correct for column resolution and band-broadening effects, such that linear homopolymer polyethylene standard is obtained at 120,000 Mw.

The total plate count of the GPC column set is performed with decane (prepared at “0.04 g in 50 milliliters” of TCB, and dissolved for 20 minutes with gentle agitation.) The plate count (Equation 2) and symmetry (Equation 3) are measured on a 200 microliter injection according to the following equations:

$$Plate Count = 5.54 * {( \frac{( R {V}_{Peak Max}}{Peak Width at \frac{1}{2} height} )}^{2} , \qquad ( EQ 2 )$$

where RV is the retention volume in milliliters, the peak width is in milliliters, the peak max is the maximum height of the peak, and ½ height is ½ height of the peak maximum; and

$$Symmetry = \frac{( Rear Peak {RV}_{one tenth height} - {RV}_{Peak m ax} )}{( {RV}_{Peak max} - Front Peak {RV}_{one tenth height} )} , \qquad ( EQ 3 )$$

where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples are prepared in a semi-automatic manner with the PolymerChar “Instrument Control” Software, wherein the samples are weight-targeted at “2 mg/ml,” and the solvent (contains 200 ppm BHT) is added to a pre nitrogen-sparged, septa-capped vial, via the PolymerChar high temperature autosampler. The samples are dissolved for two hours at 160° C. under “low speed” shaking.

The calculations of Mn_{(GPC)}, Mw_{(GPC)}, and Mz_{(GPC)} are based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{{polyethylene}_{i}} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , \qquad ( EQ 5 )$$

$$and$$

$${Mz}_{( GPC )} = \frac{{\sum }^{i} ( {IR}_{i} * {{M}_{{polyethylene}_{i}}}^{2} )}{{\sum }^{i} ( {IR}_{i} * {M}_{{polyethylene}_{i}} )} . \qquad ( EQ 6 )$$

In order to monitor the deviations over time, a flowrate marker (decane) is introduced into each sample, via a micropump controlled with the PolymerChar GPC-IR system. This flowrate marker (FM) is used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system, based on a flow marker peak, the effective flowrate (with respect to the narrow standards calibration) is calculated as Equation 7: Flowrate(effective)=Flowrate(nominal)*(RV(FM Calibrated)/RV(FM Sample)) (EQ7). Processing of the flow marker peak is done via the PolymerChar GPCOne™ Software. Acceptable flowrate correction is such that the effective flowrate is within +/−0.7% of the nominal flowrate.

### Gel Permeation Chromatography (GPC)-Propylene-Based Polymers

A high temperature Gel Permeation Chromatography (GPC) system, equipped with Robotic Assistant Deliver (RAD) system for sample preparation and sample injection, can be used. The concentration detector is an infra-red detector (IR4) from Polymer Char Inc. (Valencia, Spain). Data collection is performed using Polymer Char DM 100 Data acquisition box. The system is equipped with an on-line solvent, degas device from AGILENT. The column compartment is operated at 150° C. The columns are four, “Mixed A” LS 30 cm, 20 micron columns. The solvent is nitrogen (N2) purged, 1,2,4-trichloro-benzene (TCB), containing approximately “200 ppm” of 2,6-di-t-butyl-4-methylphenol (BHT). The flow rate is 1.0 mL/min, and the injection volume is 200 μl. A “2 mg/mL” sample concentration is prepared by dissolving the sample in “N2 purged and preheated” TCB (containing 200 ppm BHT), for 2.5 hours at 160° C., with gentle agitation.

The GPC column set is calibrated by running 20 narrow molecular weight distribution polystyrene (PS) standards. The molecular weight (MW) of the standards range from 580 to 8,400,000 g/mol, and the standards are contained in six “cocktail” mixtures. Each standard mixture has at least a decade of separation between individual molecular weights. The equivalent polypropylene molecular weight of each PS standard is calculated using the following equation (1), with reported Mark-Houwink coefficients for polypropylene (Th.G. Scholte, N. L. J. Meijerink, H. M. Schoffeleers, and A. M. G. Brands, J. Appl. Polym. Sci., 29, 3763-3782 (1984)) and polystyrene (E. P. Otocka, R. J. Roe, N. Y. Hellman, P. M. Muglia, Macromolecules, 4, 507 (1971)):

$${M}_{PP} = {( \frac{{K}_{PS} {M}_{PS}^{{a}_{PS} + 1}}{{K}_{PP}} )}^{\frac{1}{{a}_{PP} + 1}} ,$$

where M_{PP} is PP equivalent MW, M_{PS} is PS equivalent MW. The log K and a values of Mark-Houwink coefficients for PP and PS are listed below in Table A.

TABLE A

| Polymer | a | logK |
|---|---|---|
| Polypropylene | 0.725 | −3.721 |
| Polystyrene | 0.702 | −3.900 |

A logarithmic molecular weight calibration is generated using a fourth order polynomial fit as a function of elution volume. Number average and weight average molecular weights are calculated according to the following equations:

$${M}_{n} = \frac{{\sum }^{i} {Wf}_{i}}{{\sum }^{i} ( {Wf}_{i} / {M}_{i} )} , \qquad ( 2 )$$

$${M}_{w} = \frac{{\sum }^{i} ( {Wf}_{i} * {M}_{i} )}{{\sum }^{i} ( {Wf}_{i} )} , \qquad ( 3 )$$

where w_{fi} and Mᵢ, are the weight fraction and molecular weight of elution component i, respectively (note, MWD=Mw/Mn).

### Melt Index

The melt index (I2) of an ethylene-based polymer is measured in accordance with ASTM D-1238, condition 190° C./2.16 kg. The melt flow rate (MFR) of a propylene-based polymer is measured in accordance with ASTM D-1238, condition 230° C./2.16 kg, except where noted.

### Shear Adhesion Failure Temperature (SAFT)

Shear Adhesion Failure Temperature (SAFT) is measured according to ASTM D 4498, with a 500 gram weight, using a Chem instruments OSI-8 programmable oven. Each test sample is initially equilibrated at 40° C. in the oven for 10 minutes, and the oven temperature is increased at an average rate of 0.5° C./minute. The temperature at which the adhesive bond fails is recorded. Each test sample is in a shear mode configuration with the 500 gram weight.

Each SAFT test sample is prepared using two sheets of “60 g/m²” Kraft paper, each sheet is “6 in.×12 in. (152 mm×305 mm)” in dimensions. On the bottom sheet, lengthwise, and separated by a gap of one inch (25 mm), are adhered, in parallel fashion, two “1.75 in or 2 in (45 mm or 51 mm)” wide strips of a one sided, pressure-sensitive tape, such as masking tape. The two strips of tape are placed, such that the “one inch gap” runs lengthwise, down the center of the bottom sheet.

The adhesive composition (first composition) to be tested is heated to 170° C. (338° F.), and then drizzled in an even manner down the center of the “one inch gap,” formed between the two strips of tape. Then, before the composition can unduly thicken, a bonded paper template is quickly formed as follows. A rod rides immediately down the bottom sheet, leveling the adhesive composition within the gap. This rod is shimmed with a strip of the same tape on each side of the gap. After the pass of this first rod, a second sheet of the Kraft paper is aligned to, and laid on top of, the bottom sheet, and a second rod rides immediately down this top sheet, to form a bonded paper template. Overall, the first rod evenly spreads the composition in the gap region between the tape strips, and the second rod evenly compresses the second sheet over the top of the gap region and over the top of the tape strips. Within the bonded paper template, a single one inch (25.4 mm) wide strip of the adhesive composition bonds the bottom and top paper sheets. The paper template is cut crosswise into strips of “one inch (25.4 mm)” in width” and “three inches (76.2 mm)” in length, to form test samples. Each test sample had a “one inch×one inch” adhesive bond area in the center, with a bond thickness of about 8 to 10 mils (0.008 to 0.010 inch). Each test sample is cured in air for a specified time, temperature and % RH. The test samples are then used in the SAFT testing, as noted above. For each composition, two test samples are tested, and the average failure temperature recorded.

### Experimental

### Reagents and Polymer

Polymer and additives are shown in Table 1, and crosslinking agents in Table 2.

TABLE 1
Reagents and Polymers

| | Product Name | Description | Source |
|---|---|---|---|
| Polymer | AFFINITY GA | Density: 0.878 g/cm³; Melt (Brookfield) Viscosity @ 177º C. (350º F.): | Dow |
| | 1000R | 13,000 mPa•s; Approx. Melt Index: 660 g/10 min (190° C., 2.16 kg | |
| | | weight), see U.S. Pat. No. 7,199,180 (footnote to Table 1); Tm = 68° C., | |
| | | Tg = −58° C., % cryst. = 20%; | |
| | | MAH-grafted ethylene/octene copolymer. | |
| Polymer | FUSABOND | Density: 0.904 g/cm³; Melt Index: 22.4 g/10 min (160° C., 325 g weight); | Dow |
| | P353 | Tm = 132° C. (ASTM D3418); MAH-fn-polypropylene copolymer. | |
| Tackifier | ESCOREZ | Molecular Weight (Mn): 400 g/mol, Melt Viscosity @ 320 º.F (160° C.): | ExxonMobil |
| | 5400 | 800 mPa•s, Tg: 126º F. (55.2° C.). | |
| Polymer Stabilizer | IRGANOX 1010 | 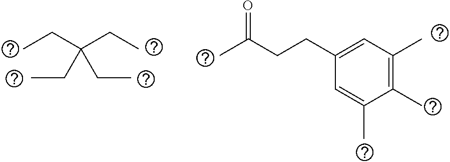 | BASF |
| | | CAS: 6683-19-8 | |

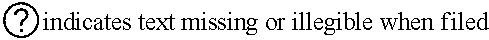

For the AFFINITY GA 1000R polymer, after a long storage time, in air, usually all or most of the anhydride groups convert to acid groups, as seen by FTIR. Thus, the AFFINITY GA 1000R was thermally treated at 180° C., for 15-20 minutes, with stirring, to completely converts the acid group into anhydride groups (anhydride treating). The conversion can be monitored by FTIR. Herein “AFFINITY GA 1000R Acid” in Table 3 below indicates AFFINITY GA 1000R without anhydride treating, while “AFFINITY GA 1000R—Anhydride” is the polymer after anhydride treating.

TABLE 2
Crosslinking Agents

| | Product Name | Description | Source |
|---|---|---|---|
| Multifunctional Epoxy 1 | 1,1,3,3-Tetramethyl-1,3- bis[2-(7- oxabicyclo[4.1.0]hept-3- yl)ethyl]disiloxane | 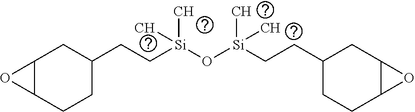 [SMILES: C[Si](C)(CCC1CCC2OC2C1)O[Si](C)(C)CCC1CCC2OC2C1] | TCI |
| | | CAS: 18724-32-8, MW = 383 | |
| Multifunctional Epoxy 2 | Bisphenol A Diglycidyl Ether | 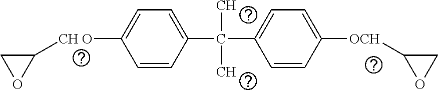 | TCI |
| | | CAS: 1675-54-3, MW = 340 | |
| Multifunctional Epoxy 3 | Di(3,4- epoxycyclohexylmethyl) adipate | 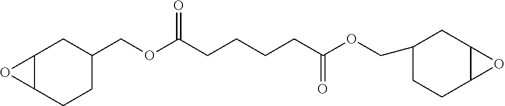 [SMILES: O=C(CCCCC(=O)OCC1CCC2OC2C1)OCC1CCC2OC2C1] | Jiangsu Tetra New Material Tech. Co. Ltd. |
| | | CAS: 3130-19-6, MW = 366 | |
| Multifunctional Epoxy 4 | EPOLEAD GT401 | 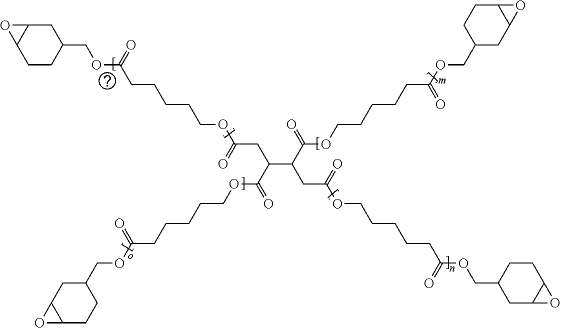 [SMILES: O=C(CCCCCOC(=O)CC(C(=O)OCCCCCC(=O)OCC1CCC2OC2C1)C(CC(=O)OCCCCCC(=O)OCC1CCC2OC2C1)C(=O)OCCCCCC(=O)OCC1CCC2OC2C1)OCC1CCC2OC2C1] | Daicel Corp. |
| | | Epoxy equivalent: 219 g/eq. | |
| | | l + m + n + o = 1 (average) | |
| Multifunctional | EPOLEAD PB3600 | Structure* | Daicel |
| Epoxy5 | | Oxirane oxygen: 8.3 wt %, epoxy equiv.: 193 g/eq. | Corp |
| Oxetanyl 1 | Bis(1-ethyl(3- oxetanil)methyl) ether | 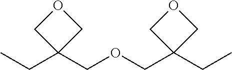 CAS: 18934-00-4, MW = 214 | Changzhou Tronly New Electronics Materials Co., Ltd. |

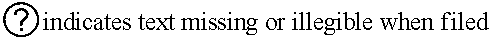

*Structure =

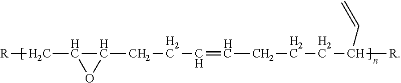

### Study 1—FTIR Analysis of the Crosslinking Reaction

### FTIR Testing

A first composition, before and after cure, was examined by Fourier Transform Infrared (FTIR) spectroscopy, using a single-reflection ATR attachment, equipped with a diamond crystal. Depth of penetration during the ATR analysis was estimated to be two microns. The spectrum was collected using a Thermo Electron Nicolet 5700 Optical Bench, with 32 scans at 4 cm⁻¹ resolution.

### Preparation of FTIR Film

### First Composition

The composition components (70 g AFFINITY GA 1000R Anhydride, 30 g Tackifier ESCOREZ 5400 and 0.5 g IRGANOX 1010), except the crosslinker, were added to a 250 mL, stainless steel container. This container was then placed in an air circulating oven, and the temperature was increased to 180° C. (oven temp.), and the composition was thermally treated until completely melted (30-60 minutes). The composition was then stirred with a mechanical stirrer for 15 minutes at 180-200° C. Next, Multifunctional Epoxy 1 (1.25 g) was added, and the resulting mixture was stirred for 10 minutes at 180-200° C. The final mixture was then poured into a 1 mm thick film mold, and allowed to cool, to obtain a film for the FTIR testing (see IE 1 in Table 3 below).

### Crosslinked Composition

The above film was cured under the following condition: 22° C./50% RH, air circulating oven, for 8 days. FTIR spectra were taken at the following times: a) after formation of the first composition (180° C., 1 hour), b) after 3 days of cure, and c) after 8 days of cure. The FTIR spectrum of AFFINITY GA 1000R Acid was also taken for a comparison of peak positions.

### Analysis of the Data

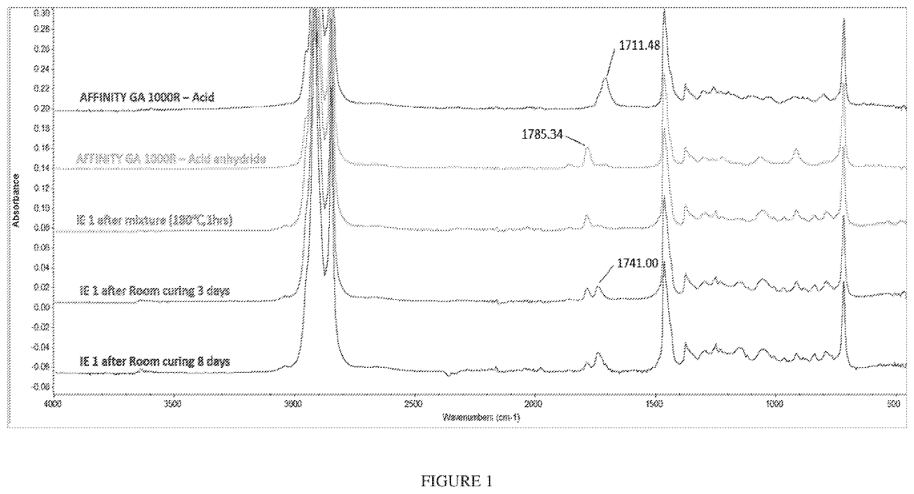

An overlay of the FTIR profiles is shown in FIG. 1. The C═O signal of acid is around 1711 cm⁻¹, while anhydride signal is around 1785 cm⁻¹. The FTIR profile of the first composition, just after formation, showed that no ester signal (around 1741 cm⁻¹) was present in the first composition. A signal from the anhydride (around 1785 cm⁻¹) was present, which indicated that no appreciable reaction between anhydride groups of the MAH-g-polymer and the multifunction epoxy compound occurred during the mixture step (physical blending).

The FTIR profiles after 3 and 8 days of cure showed a decrease in the anhydride signal (1785 cm⁻¹), and an increase in the ester bond signal (1741 cm⁻¹). These results strongly demonstrate a proposed mechanism, such as shown in Scheme 1 below. In Scheme 1, each asterisk (*) independently represents a portion of the respective remaining polymer chain bonded to the respective end of the —CH2-CHZ— group noted below, where Z is the pendant crosslinked site between the two polymer chains.

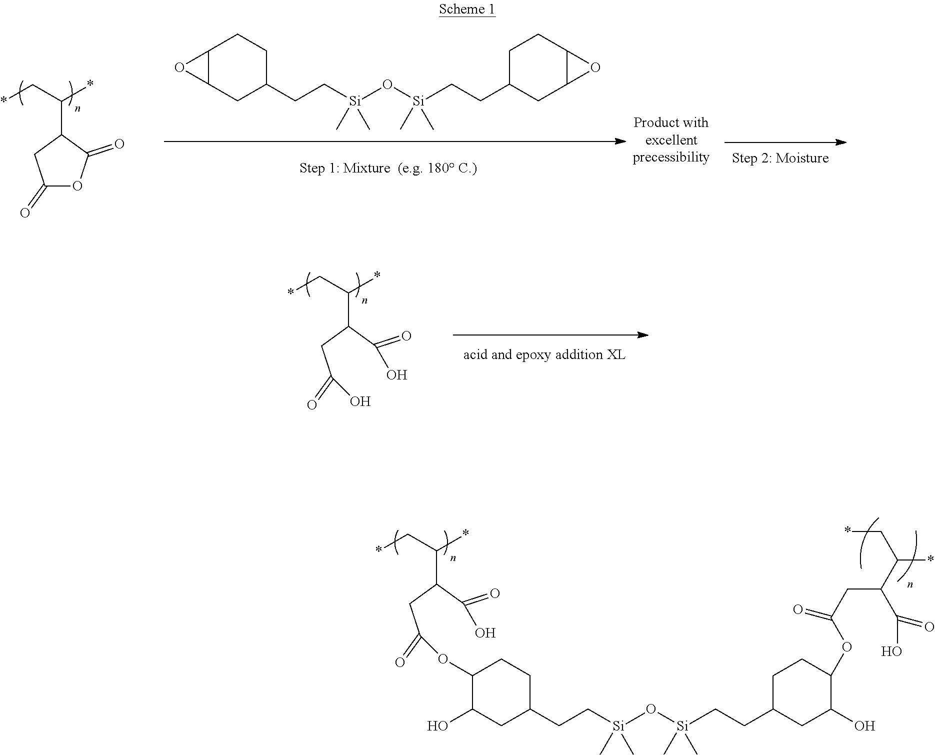

### Study 2—Thermal Stability and Adhesion

### Preparation of the First Composition and Viscosity Stability

### First Composition Containing the “AFFINITY GA 1000R—Anhydride”

For each composition, the corresponding components, as shown in Table 3, except for the crosslinker (multifunctional epoxy compound or oxetane compound), were weighed into a stainless steel container (250 mL), which was placed in an oven (air circulating), and heated at a temperature of 180° C. (oven temp.), for 30-60 minutes, until the composition was melted. The container was transferred to a heating device, and the composition was then melt blended, at a temperature from 180-200° C., for 15 minutes, with a “Paravisc style” mixing head, running at 90-150 rotations per minute (rpm). The crosslinker was added, and the composition was stirred for 10 minutes at 180-200° C.

The viscosity stability of each first composition (IE 1-IE 7) was examined by measuring the melt viscosity of the composition over time. Results are shown in Table 4.

### First Composition Containing the “AFFINITY GA 1000R—Acid”

The components of the composition (CE 2), as shown in Table 3, were weighed into the stainless steel container, and melt blended, at a temperature from 180-200° C., for 15 minutes, with the “Paravisc style” mixing head, running at 90-150 rotations per minute (rpm). The composition gelled during this mixing stage.

### Cure of the First Composition (see Table 5, CE 1, CE 3 and IE 1-IE 7)

A SAFT test sample was made for each composition-see Test Methods section above. Each first composition was cured using one or more curing profiles, in air (22° C.) or in an air circulating oven (35° C. or 85° C.), as follows: a) cure at 22° C., 50% RH, for 7 days, b) cure at 35° C., 85% RH, for 1, 2, 3, 4 or 7 days, or c) cure at 85° C., 85% RH, for 7 days. The cohesion of each crosslinked composition was determining using the SAFT test. Results are shown in Table 5. For the above curing profiles, an oven temperature is represented at 35° C. and 85° C.; however, the test sample quickly equilibrated to the oven temperature in less than 10 minutes. Also, the temperature of 22° C. was that of the air temperature in a controlled lab environment. The % RH in the oven was controlled by a built-in humidity monitoring device, and the % RH at 22° C. was also controlled by a similar device.

### Summary of Results—Study 2

As seen in Table 4, the first compositions of the inventive examples (IE 1-IE 7) had excellent thermal stability. For example, after 2 hours at 140° C., the increase melt viscosity was less than 36% (IE 3 and IE 4). After 2 hours at 177° C., the increase in melt viscosity was less than 19% (IE 1 and IE 2).

In regard to the adhesion results, the inventive examples had significantly higher SAFT values than the respective comparative controls, as seen in Table 5. For example, after curing for 7 days at 22° C. and 50% RH, the inventive examples (IE 1-IE 5 and IE 7) had SAFT values from about 80° C. to about 102° C., while the comparative control (CE 1) had a SAFT value of about 73° C. After curing for 7 days at 35° C. and 85% RH, the inventive examples (IE 1-IE 5 and IE 7) had SAFT values from about 84° C. to ≥170° C., while the comparative control (CE 1) had a SAFT value of about 73° C. After curing for 7 days at 85° C. and 85% RH, the inventive examples (IE 1-IE 5 and IE 7) had SAFT values from about 133° C. to ≥170° C., while the comparative control (CE 1) had a value of about 73° C.

After a “7 day cure” at 22° C. and 50% RH, the inventive example IE 6 had a SAFT value of about 156° C., while the comparative control (CE 3) had a SAFT value of about 151° C. After curing for 7 days at 35° C. and 85% RH, example IE 6 had a SAFT value of >170° C., while the comparative control (CE 3) had a SAFT value of about 151° C. After curing for 7 days at 85° C. and 85% RH, example IE 6 had a SAFT value of >170° C., while the comparative control (CE 3) had a SAFT value of about 151° C.

Inventive examples IE 1 and IE 2 had excellent high temperature stability, each with a viscosity was <16,000 mPa·s, and with a viscosity increase <60% after 3 hours at 177° C. The CE 2 example gelled due to the reaction of the acid group with epoxy. In comparison to the benchmark control CE 1, the SAFT values of inventive examples (IE 1-IE 5 and IE 7), after curing at 85° C./85% RH, 7 days, were significant higher, indicating that each crosslinking agent resulted in a high degree of crosslinking. See also the good results for IE 6.

As discussed above, it has been discovered that the inventive compositions have excellent high temperature stability and curing performance. The data confirm that anhydride and each crosslinking agent did not react to any appreciable extent, during the formation of the physical blend at elevated temperatures. This results in the excellent viscosity stability of the first composition, at high temperature, to provide for a long term, stable processing window. During the moisture cure, the anhydride will hydrolyze to form the diacid, and one acid group will react with the crosslinking agent. The inventive compositions are well suited for adhesive applications.

TABLE 3
First Compositions

| | | CE 1 | | CE 3 | | |
|---|---|---|---|---|---|---|
| | | control | CE 2 | control | IE 1 | IE 2 |
| AFFINITY GA 1000R acid (1.2 wt %)^{A} | | | 70.00 | | | |
| AFFINITY GA 1000R Anhydride (1.2 wt %)^{A} | | 70.00 | | | 70.00 | 70.00 |
| FUSABOND P353 Anhydride (MAH 1.6 wt %) | | | | 70.00 | | |
| Tackifier (ESCORES 5400) | | 30.00 | 30.00 | 30.00 | 30.00 | 30.00 |
| IRGANOX 1010 | | 0.50 | 0.50 | 0.50 | 0.50 | 0.50 |
| 1,1,3,3-Tetramethyl-1,3-bis[2-(7- | | | 1.62 | | 1.62 | |
| oxabicyclo[4.1.0]hept-3- | | | | | | |
| yl)ethyl]disiloxane (CAS: 18724-32-8; Mw 383) | | | | | | |
| Bisphenol A Diglycidyl Ether (CAS 1675-54-3; Mw 340) | | | | | | 1.44 |
| GT 401 (epoxy equivalent: 219 g/eq.) | | | | | | |
| PB 3600 (Oxirane Oxygen: 8.3 wt. %, epoxy equivalent: 192 g/eq.) | | | | | | |
| DOX (TCM201, CAS: 18934-00-4; Mw 214) | | | | | | |
| TTA-26 (CAS: 3130-19-6; Mw 366) | | | | | | |
| Total (weight parts) | | 100.50 | 102.12 | 100.50 | 102.12 | 101.94 |
| Calculation | Mole of MAH^{B} | 0.0085 | 0.0085 | 0.0113 | 0.0085 | 0.0085 |
| | Mole of Oxirane (epoxide) group or Oxetane group | 0.0000 | 0.0000 | 0.0000 | 0.0085 | 0.0085 |
| | Mole ratio of Oxirane (epoxide) group/MAH or mole | 0.00 | 0.00 | 0.00 | 1.00 | 1.00 |
| | ratio of Oxetane group/MAH | | | | | |
| | | IE 3 | IE 4 | IE 5 | IE 6 | IE 7 |
| AFFINITY GA 1000R acid (1.2 wt %)^{A} | | | | | | |
| AFFINITY GA 1000R Anhydride (1.2 wt %)^{A} | | 70.00 | 70.00 | 70.00 | | 70.00 |
| FUSABOND P353 Anhydride (MAH 1.6 wt %) | | | | | 70.00 | |
| Tackifier (ESCORES 5400) | | 30.00 | 30.00 | 30.00 | 30.00 | 30.00 |
| IRGANOX 1010 | | 0.50 | 0.50 | 0.50 | 0.50 | 0.50 |
| 1,1,3,3-Tetramethyl-1,3-bis[2-(7- | | | | | 2.17 | |
| oxabicyclo[4.1.0]hept-3- | | | | | | |
| yl)ethyl]disiloxane (CAS: 18724-32-8; Mw 383) | | | | | | |
| Bisphenol A Diglycidyl Ether (CAS 1675-54-3; Mw 340) | | | | | | |
| GT 401 (epoxy equivalent: 219 g/eq.) | | 2.48 | | | | |
| PB 3600 (Oxirane Oxygen: 8.3 wt. %, epoxy equivalent: 192 g/eq.) | | | 2.17 | | | |
| DOX (TCM201, CAS: 18934-00-4; Mw 214) | | | | | | 0.91 |
| TTA-26 (CAS: 3130-19-6; Mw 366) | | | | 1.55 | | |
| Total (weight parts) | | 102.98 | 102.67 | 102.05 | 102.67 | 101.41 |
| Calculation | Mole of MAH^{B} | 0.0085 | 0.0085 | 0.0085 | 0.0113 | 0.0085 |
| | Mole of Oxirane (epoxide) group or Oxetane group | 0.0113 | 0.0113 | 0.0085 | 0.0113 | 0.0085 |
| | Mole ratio of Oxirane (epoxide) group/MAH or mole | 1.33 | 1.33 | 1.00 | 1.00 | 1.00 |
| | ratio of Oxetane group/MAH | | | | | |

^{A}The wt % of anhydride or acid can be determined by an acid-base titration. For example, see titration method described in I. Rahayu, Maleic Anhydride Grafted onto High Density Polyethylene with an Enhanced Grafting Degree via Monomer Microencapsulation, Heliyon, 6, 2020, 1-6.
^{B}MAH = maleic anhydride (grafted).

TABLE 4
Thermal Stability of First Compositions

| | | | CE 1 | CE 2 | CE 3 | IE 1 | IE 2 | IE 3 | IE 4 | IE 5 | IE 6 | IE 7 |
|---|---|---|---|---|---|---|---|---|---|---|---|---|
| Viscosity | 1 | hr | 41,571 | Gel | — | — | — | — | — | — | — | 37,912 |
| mPa · s (or cP)/120° C. | 2 | hrs | 41,645 | — | — | — | — | — | — | — | — | 38,272 |
| (% Δηt) | | | | | | | | | | | | (0.95%) |
| | 3 | hrs | 40,451 | — | — | — | — | — | — | — | — | 38,392 |
| | | | | | | | | | | | | (1.3%) |
| | 4 | hrs | 40,235 | — | — | — | — | — | — | — | — | 38,752 |
| | | | | | | | | | | | | (2.2%) |
| Viscosity | 1 | hr | | — | — | — | — | 66,086 | 49,090 | — | — | — |
| mPa · s (or cP)/140° C. | 2 | hrs. | | — | — | — | — | 85,182 | 66,486 | — | — | — |
| (% Δηt) | | | | | | | | (28.9%) | (35.4%) | | | |
| Viscosity | 1 | hr | — | — | 35,872 | — | — | — | — | 31,593 | 43,791 | — |
| mPa · s (or cP)/150° C. | 2 | hrs | — | — | 36,112 | — | — | — | — | 51,289 | 47,870 | — |
| (% Δηt) | | | | | | | | | | (62.3%) | (9.3%) | |
| | 3 | hrs | — | — | 36,532 | — | — | — | — | 72,485 | — | — |
| | | | | | | | | | | (129.4%) | | |
| | 4 | hrs | — | — | 37,312 | — | — | — | — | — | — | — |
| Viscosity | 1 | hr | 5,969 | — | — | 9,858 | 6,039 | — | — | — | — | — |
| mPa · s (or cP)/177° C. | 2 | hrs | — | — | — | 11,698 | 6,369 | — | — | — | — | — |
| (% Δηt) | | | | | | (18.7%) | (5.5%) | | | | | |
| | 3 | hrs | — | — | — | 14,997 | 7,068 | — | — | — | — | — |
| | | | | | | (52.1%) | (17.0%) | | | | | |

Gel—viscosity approached infinity. No viscosity stability. At a specified temperature (° C.), the % Δη(t) = [(ηt − η1)/η1] × 100, where ηt = viscosity at time t (in hours) and η1 = viscosity at 1 hour.

TABLE 5
Adhesion Results of Crosslinked Compositions

| | | CE 1 | CE 2 | CE 3 | IE 1 | IE 2 | IE 3 | IE 4 | IE 5 | IE 6 | IE 7 |
|---|---|---|---|---|---|---|---|---|---|---|---|
| SAFT ° C. | 7 days | 72.9 | — | 151.0 | 91.9 | 79.7 | 90.5 | 82.2 | 102.0 | 156.4 | 82.0 |
| 22° C./50% RH | | | | | | | | | | | |
| SAFT ° C. | 1 day | — | — | — | 91.4 | 80.1 | — | — | — | — | — |
| 35° C./85% RH | 2 days | — | — | — | 110.6 | — | — | — | — | — | — |
| | 3 days | — | — | — | 113.7 | — | — | — | — | — | — |
| | 4 days | — | — | — | — | 87.6 | — | — | — | — | — |
| | 7 days | 72.9 | — | 151.0 | — | 88.2 | >170 | 98.9 | 138.5 | >170 | 83.5 |
| SAFT ° C. | 7 days | 72.9 | — | 151.0 | >170 | >170 | >170 | 133.0 | 165.4 | >170 | 142.3 |
| 85° C./85% RH | | | | | | | | | | | |

1. A process to form a composition comprising a crosslinked olefin-based polymer derived from an anhydride-functionalized olefin-based polymer, said process comprising at least the following steps A) and B):
A) mixing together at least the following components a and b to form a first composition:
a) the “anhydride-functionalized olefin-based polymer, and
b) at least one multifunctional epoxy compound comprising at least two epoxy groups, or at least one oxetane compound comprising at least one oxetane group;
B) exposing the first composition to moisture to form the crosslinked olefin-based polymer.

2. The process of claim 1, wherein the multifunctional epoxy compound is selected from structures e11), e12), e21), e31), e41), e51), e71) or 81) below; and the oxetane compound is selected from o41) below:

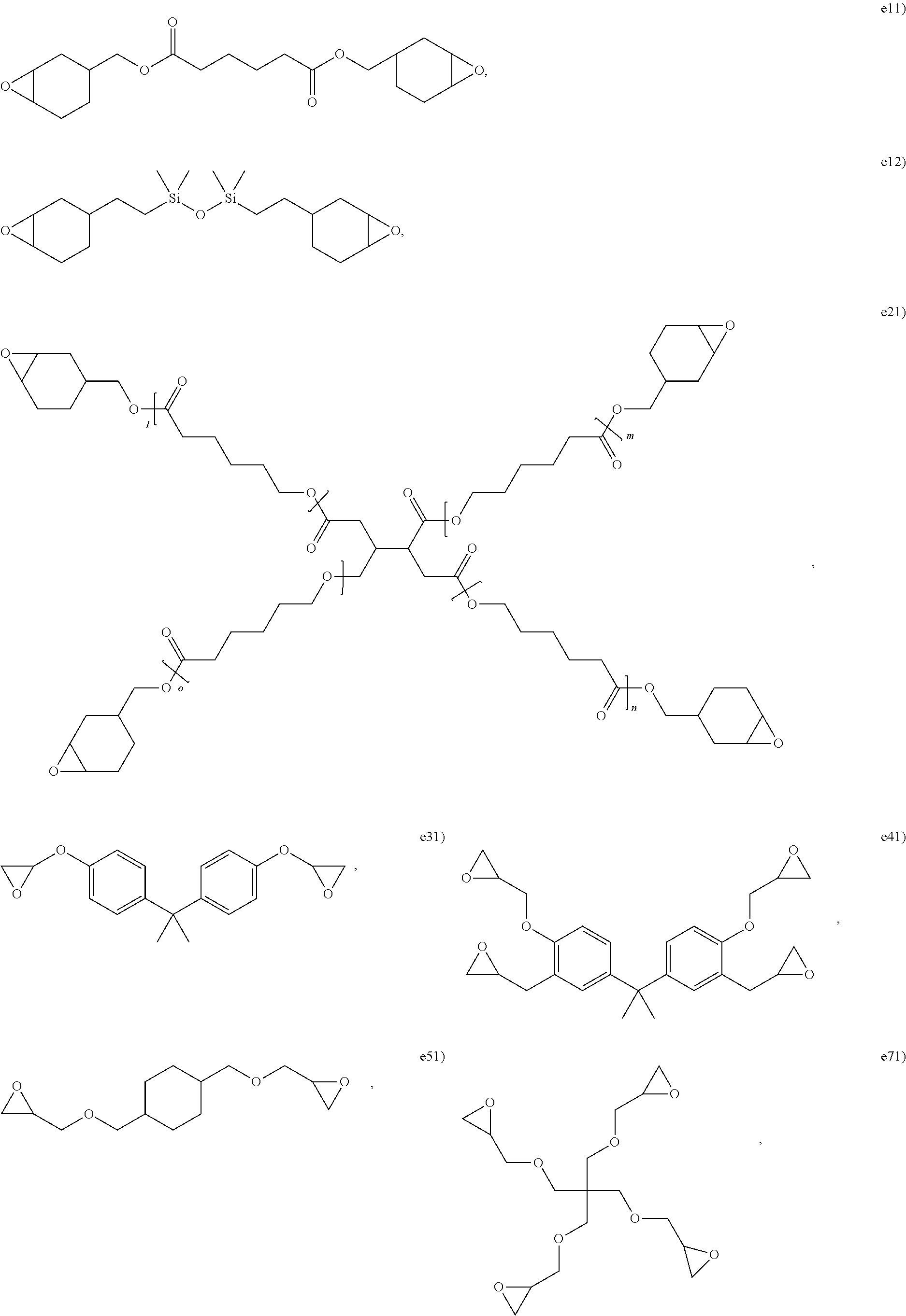

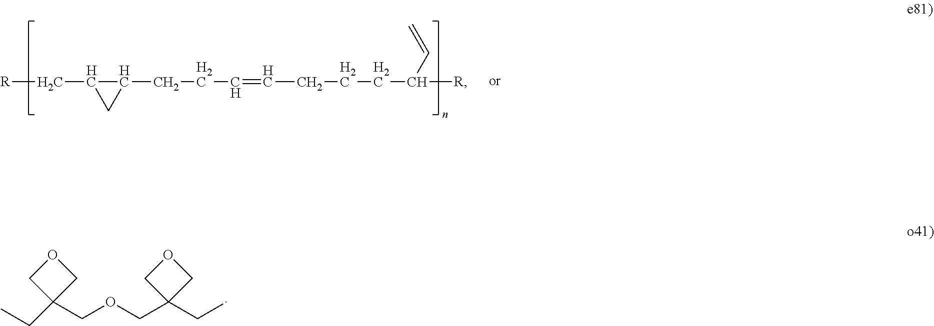

3. The process of claim 1, wherein component b is at least one multifunctional epoxy compound.

4. The process of claim 1, wherein component b is at least one oxetane compound.

5. The process of claim 1, wherein component a is an anhydride-functionalized ethylene-based polymer.

6. The process of claim 1, wherein component a is an anhydride-functionalized propylene-based polymer.

7. A crosslinked composition formed from the process of claim 1.

8. A first composition comprising at least the following components a and b:
a) an anhydride-functionalized olefin-based polymer;
b) at least one multifunctional epoxy compound comprising at least two epoxy groups, or at least one oxetane compound comprising at least one oxetane group.

9. The first composition of claim 8, wherein the multifunctional epoxy compound is selected from structures e11), e12), e21), e31), e41), e51), e71) or 81) below and the oxetane compound is selected from o41) below:

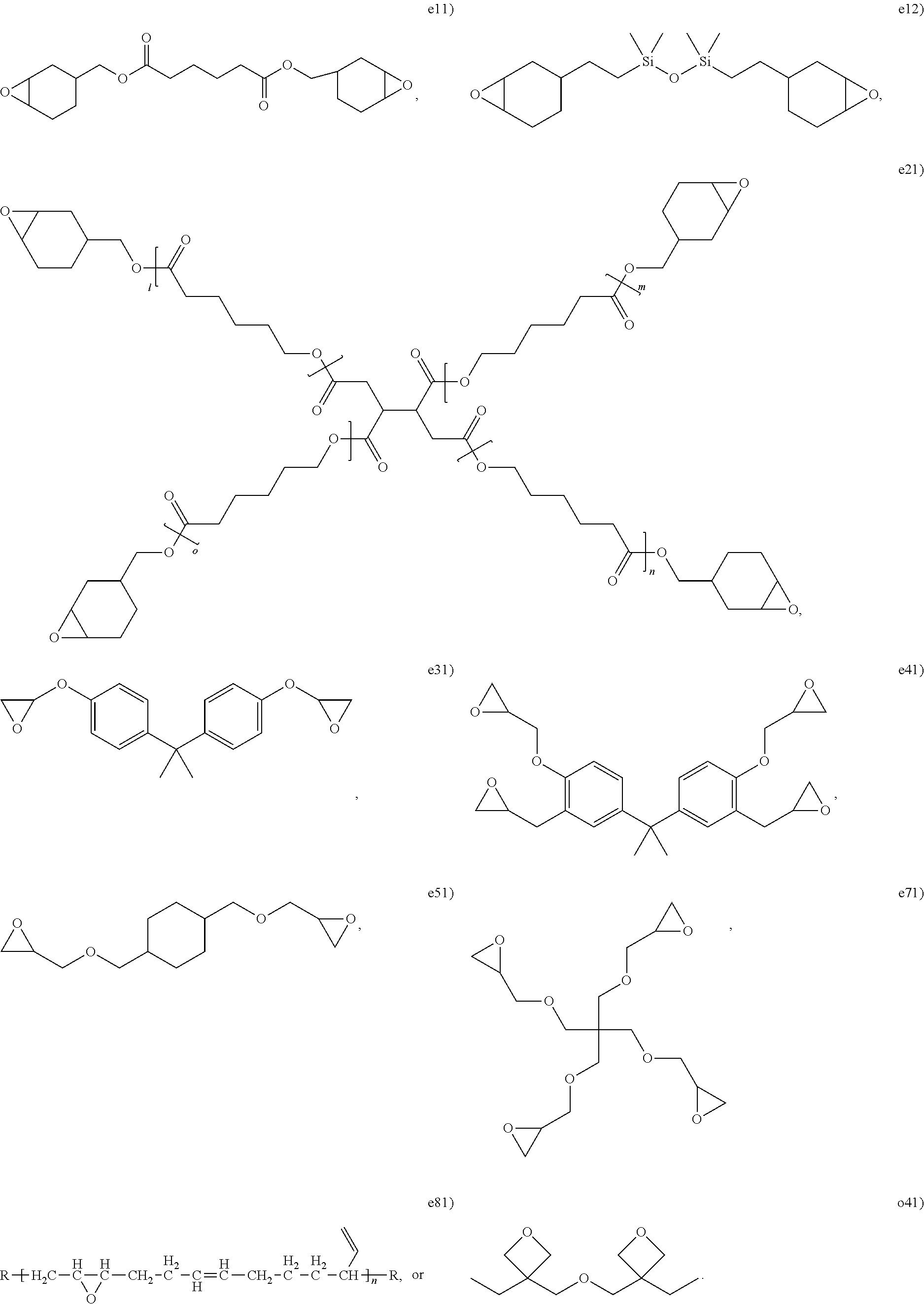

10. The first composition of claim 8, wherein component b is at least one multifunctional epoxy compound.

11. The first composition of claim 8, wherein component b is at least one oxetane compound.

12. The first composition of claim 8, wherein component a is an anhydride-functionalized ethylene-based polymer.

13. The first composition of claim 8, wherein component a is an anhydride-functionalized propylene-based polymer.

14. The first composition of claim 8, wherein component a has a density from 0.860 g/cc to 0.920 g/cc (1 cc=1 cm³).

15. The first composition of claim 8, wherein the weight ratio of component a to component b is from 20 to 90.

16. The first composition of claim 8, wherein the first composition further comprises a tackifier (component c).

17. The first composition of claim 8, wherein the first composition has a percent increase in melt viscosity after 3 hours at 177° C. (% Δη3 at 177° C.)≤65%.

18. The first composition of claim 8, wherein the first composition, after seven days at 85° C., 85% RH, in air, has SAFT value ≥100° C.

19. A crosslinked composition formed from the first composition of claim 8.

20. An article comprising at least one component formed from the composition of claim 7.
